(19) United States
(12) Patent Application Publication
(10) Pub. No.: US 2024/0101782 A1
(43) Pub. Date: Mar. 28, 2024

(54) CATALYSTS, COMPOSITIONS, AND METHODS FOR RING CLOSING DEPOLYMERIZATION

(71) Applicant: The Trustees of Boston College, Chestnut Hill, MA (US)

(72) Inventors: Jeffery Byers, Newton, MA (US); Connor Gallin, Yonkers, NY (US)

(21) Appl. No.: 18/453,763

(22) Filed: Aug. 22, 2023

Related U.S. Application Data
(60) Provisional application No. 63/373,115, filed on Aug. 22, 2022.

(51) Int. Cl. C08J 11/16

(52) U.S. Cl. CPC C08J 11/16; C08J 2335/02; C08J 2369/00

(57) ABSTRACT

The disclosure provides compositions comprising a polymer, a Lewis acid, and a solvent and methods of using the same for ring closing depolymerization of polymers.

### CROSS-REFERENCE TO RELATED APPLICATION

This application claims the benefit of U.S. Provisional Patent Application No. 63/373,115, filed Aug. 22, 2022, which is incorporated by reference herein in its entirety.

### STATEMENT AS TO FEDERALLY SPONSORED RESEARCH

This invention was made with government support under Grant Number OD026910 awarded by the National Institutes of Health; Grant Number W911NF-15-1-0454 awarded by U.S. Army Research Office; and Grant Numbers CHE2117246 MRI Award and CHE1955926 awarded by the National Science Foundation. The government has certain rights in the invention.

### FIELD

The disclosure relates generally to compositions and methods of using the same for ring closing depolymerization of polymers.

### BACKGROUND

Synthetic polymer production exceeds 350 million metric tons annually, which is projected to exceed half a billion metric tons annually by 2050. Current commodity polymers have not incorporated end of life into their design, which poses a problem for their ultimate fate. Compounding this problem is that only a small fraction of the recovered waste undergoes recycling. Consequently, most polymeric waste ends up in landfills or is burned for thermal energy. Most plastic waste that is recycled uses a mechanical recycling strategy. This method largely results in downcycled products due to impurities introduced during use and/or from reprocessing. Additionally, the waste stream consists of polymer blends that are difficult to separate and incompatible with one another, which ultimately compromises the recycled polymers' mechanical properties.

An attractive alternative for closed-loop recycling is chemical recycling, a process where the polymer is chemically transformed back into its constituent monomer. This method avoids problems with impurities introduced during polymer use and reprocessing, and developing chemoselective depolymerization methods addresses the mixed polymer waste problem.

### SUMMARY

In one aspect, the disclosure provides catalysts, compositions, and methods for ring closing depolymerization. In some embodiments, the disclosure provides a composition for ring closing depolymerization, comprising a polymer, a Lewis acid, and a solvent. In some embodiments, the disclosure provides a method for ring closing depolymerization comprising mixing a reaction composition comprising a polymer, a Lewis acid, and a solvent; and heating the reaction composition.

### BRIEF DESCRIPTION OF THE DRAWINGS

FIG. 1 shows a TGA thermograph of pECL in the presence of different Lewis acid catalysts.

FIG. 2 shows a stepped isothermal TGA heating program for pECL degradation in the presence of 10 wt % ZnCl₂. Each bar represents mass loss over 30 minutes. Numbers above bars represent the estimated half-life in hours for pECL degradation, assuming first order kinetics.

FIG. 3A shows pECL depolymerization at 160° C. after 2 h in different solvents. FIG. 3B shows pECL depolymerization at 160° C. in EG at different reaction times. All reactions included 10 wt % ZnCl₂.

FIG. 4 shows Isothermal TGA of pECL with ZnCl₂/PEG600 catalyst system at different temperatures.

FIG. 5A shows Stepped Isothermal TGA heating program, each temperature held for 30 minutes and loss mass measured for 30 minutes. Each bar represents calculated weight loss over 1 hour assuming first order kinetics. FIG. 5B shows Stepped Isothermal TGA of pPDL in the presence of ZnCl₂:PEG600. Each bar represents 30 minutes of mass loss at each temperature. Numbers above bars represent calculated half-life in hour for each temperature.

FIG. 6A shows mass of collected distillate (●.), remaining polymer mass (♦), and mass balance (x) for pECL depolymerization catalyzed by ZnCl₂/PEG600 under reactive distillation (0.1 Torr) at different reaction times. FIG. 6B shows polymer molecular weight (Mn, ▪) and dispersity (Mw/Mn, ▴) of remaining polymer during the reactive distillation at different reaction times.

FIG. 7 shows optimal PEG600/ZnCl 2 stoichiometry. Normalized for the number of ethylene glycol repeat units in PEG 600. Reaction conditions: 0.400 g of pECL, 160° C., 0.1 torr, 4 h. Polymer mass loss (●, left y-axis) monomer purity (▴, right y-axis).

FIG. 8 shows depolymerization by reactive distillation of various polymers. Isolated yields after reactive distillation a) 2% meso content, 99.4% ee b) cyclic dimer obtained as major product; c) Rxn. at 210° C., cyclic monomer obtained as sole product.

FIG. 9A-C shows mixed polymer waste depolymerization. FIG. 9A shows the starting mixed polymer waste, pECL with equal amounts of post-consumer poly(ethylene terephthalate) (PET), isotactic poly(propylene) (i-PP), and linear low density poly(ethylene) (LLDPE). FIG. 9B shows the mixed polymer waste before depolymerization. FIG. 9C shows the mixed polymer waste after depolymerization.

FIG. 10 shows a reactive distillation of ECL from a mixture of post consumer pECL, PET, LLDPE, and i-PP. ¹H NMR spectra of initial ECL monomer (top), pECL (middle), and recycled ECL (bottom).

FIG. 11 shows a general schematic of ring closing depolymerization of exemplary polyesters and polycarbonates.

FIG. 12 shows TGA thermographs of pECL degradation in the presence of Lewis Acids with PEG600. Heating rate of 4°/min with N₂ purge and protective gases.

FIG. 13 shows depolymerization time course reactive distillation GPC traces.

FIG. 14A shows ¹H NMR of crude reaction mixture of pPDL polymerization. FIG. 14B shows ¹H NMR of synthesized pPDL polymer in CDCl₃. Minor monomer impurities remain (<5%).

FIG. 15 shows ¹H NMR of collected distillate from reactive distillation of pECL. ¹H NMR (600 MHz, CDCl₃): δ 4.19 (A,m, 2H), 2.60 (E,m, 2H), 1.81 (B, m, 2H), 1.72 (D+C,m, 4H) ppm. The ¹H NMR spectrum was consistent with previously reported literature.

FIG. 16 shows ¹H NMR of collected distillate from reactive distillation of poly(δ-valerolactone). ¹H NMR (500 MHz, CDCl₃): δ 4.34-4.23 (A, t, J=5.6 Hz, 2H), 2.49 (D, t, J=7.0 Hz, 2H), 1.91-1.75 (B+C, m, 4H) ppm. The ¹H NMR spectrum was consistent with previously reported literature.

FIG. 17 shows ¹H NMR of collected distillate from reactive distillation of pLLA. ¹H NMR (500 MHz, CDCl₃): δ 5.04 (B, q, J=6.5 Hz, 2H), 1.69 (A, d, J=6.7 Hz, 6H) ppm. The ¹H NMR spectrum was consistent with previously reported literature.

FIG. 18 shows ¹H NMR of collected distillate from reactive distillation poly(propylene carbonate) ¹H NMR (600 MHz, CDCl₃), 4.81 (B, m, 1H), 4.51 (C, t, J=8.12 Hz, 1H), 3.98 (D, t, J=7.9 Hz, 1H), 1.43 (A, d, J=6.3 Hz, 3H) ppm. The ¹H NMR spectrum was consistent with previously reported literature.

FIG. 19 shows ¹H NMR of collected distillate from reactive distillation of poly(trimethylene carbonate) ¹H NMR (600 MHz, CDCl₃) 4.44 (A, t, J=5.7 Hz, 4H), 2.13 (B, m, 2H). The ¹H NMR spectrum was consistent with previously reported literature.

FIG. 20 shows ¹H NMR of collected distillate from reactive distillation of pPDL ¹H NMR (500 MHz, CDCl₃) 4.13 (A, t, J=5.6 Hz, 2H), 2.32 (N, t, J=6.8 Hz, 2H), 1.78-1.54 (B+M, m, 4H), 1.48-1.17 (C-L, m, 20 H) ppm. The ¹H NMR spectrum was consistent with previously reported literature.

FIG. 21 shows ¹H NMR of distillate from recycled p(HDL) ¹H H NMR (600 MH CDCl₃) δ 5.41-5.27 (E +F, m, 2H), 4.12-4.07 (P, t, 2H), 2.28 (A, t, 2H), 2.04-1.96 (D +G, q, 4H), 1.66-1.55 (C +B, m, 4H), 1.43-1.21 (H-N, m, 14H). The ¹H NMR spectrum was consistent with previously reported literature.

FIG. 22 shows combined stepped isothermal TGA of pECL Stepped isothermal TGA heating program, each temperature held for 30 minutes and loss mass measured for 30 minutes. Number above bars estimated half-life of pECL degradation.

FIG. 23 shows catalyst recycling experiments: 20 wt % PEG600, 10 wt % ZnCl₂, 1 g polymer. After each cycle, 1 g of polymer was added and the reaction was heated at 160° C. under 0.1 torr vacuum for 16 hours. Monomer yield and purity were determined by ¹H NMR using an internal standard.

### DETAILED DESCRIPTION

Synthetic polymer production exceeds 350 million metric tons annually, which is projected to exceed half a billion metric tons annually by 2050. Current commodity polymers have not incorporated end of life into their design, which poses a problem for their ultimate fate. Compounding this problem is that only a small fraction of the recovered waste undergoes recycling. Consequently, most polymeric waste ends up in landfills or is burned for thermal energy. Most plastic waste that is recycled uses a mechanical recycling strategy. This method largely results in downcycled products due to impurities introduced during use and/or from reprocessing. Additionally, the waste stream consists of polymer blends that are difficult to separate and incompatible with one another, which ultimately compromises the recycled polymers' mechanical properties.

An attractive alternative for closed-loop recycling is chemical recycling, a process where the polymer is chemically transformed back into its constituent monomer. This method avoids problems with impurities introduced during polymer use and reprocessing, and developing chemoselective depolymerization methods addresses the mixed polymer waste problem.

A number of closed loop ring opening polymerization systems have exploited the propensity of low ceiling temperature (T_{C}) polymers that depolymerize under mild conditions. The depolymerization of these polymers takes advantage of low ring-strain in the monomer that make depolymerization enthalpically favorable. Consequently, the polymerization of these monomers requires low temperatures, extremely active catalysts, conditions that favor polymer precipitation, or monomers that involve multistep syntheses, which limits scalability and their practical use as commodity polymers.

In order to depolymerize polymers with moderate to high T_{C} under relatively mild conditions, the thermodynamic preference for polymerization must be circumvented. One way to achieve this goal is to carry out the depolymerization reactions under reactive distillation conditions, which prevents the polymer/monomer equilibrium from being established by removing the monomer as soon as it is formed. Despite this advantage, reactive distillation of moderate to high T_{C} polymers derived from ring-opening polymerization are uncommonly carried out significantly below the polymer T_{C}. The high temperatures (>200° C.) often used result in unselective depolymerization reactions. For example, L-lactide (LLA) production involves the oligomerization of lactic acid followed by Lewis-acid catalyzed, ring-closing depolymerization at high temperatures (>200° C.). Unwanted side reactions, such as decarboxylation, dehydration, and epimerization are problematic at high conversion and when using higher molecular weight poly(L-lactic acid) (PLLA). Altering the identity of catalysts can lead to more selective depolymerization of PLLA and other moderate T_{C} polymers, but most depolymerization reactions are carried out near the T_{C} of the polymers. Moreover, there are no general catalysts applied for a wide variety of polymers.

In one aspect, the disclosure provides a simple and general catalyst for the ring-closing depolymerization of polymers derived from cyclic esters and cyclic carbonates that operates at temperatures significantly below the polymer T_{C}.

### Definitions

Unless defined otherwise, all technical and scientific terms used herein have the same meaning as is commonly understood by one of skill in the art to which this invention belongs. All patents and publications referred to herein are incorporated by reference in their entireties.

Compounds of the invention also include crystalline and amorphous forms of those compounds, including, for example, polymorphs, pseudopolymorphs, solvates, hydrates, unsolvated polymorphs (including anhydrates), conformational polymorphs, and amorphous forms of the compounds, as well as mixtures thereof. “Crystalline form” and “polymorph” are intended to include all crystalline and amorphous forms of the compound, including, for example, polymorphs, pseudopolymorphs, solvates, hydrates, unsolvated polymorphs (including anhydrates), conformational polymorphs, and amorphous forms, as well as mixtures thereof, unless a particular crystalline or amorphous form is referred to.

For the avoidance of doubt, it is intended herein that particular features (for example integers, characteristics, values, uses, formulae, compounds, or groups) described in conjunction with a particular aspect, embodiment or example of the invention are to be understood as applicable to any other aspect, embodiment or example described herein unless incompatible therewith. Thus, such features may be used where appropriate in conjunction with any of the definition, claims or embodiments defined herein. All of the features disclosed in this specification (including any accompanying claims, abstract and drawings), and/or all of the steps of any method or process so disclosed, may be combined in any combination, except combinations where at least some of the features and/or steps are mutually exclusive. The invention is not restricted to any details of any disclosed embodiments. The invention extends to any novel one, or novel combination, of the features disclosed in this specification (including any accompanying claims, abstract and drawings), or to any novel one, or any novel combination, of the steps of any method or process so disclosed.

Moreover, as used herein, the term “about” means that dimensions, sizes, formulations, parameters, shapes and other quantities and characteristics are not and need not be exact, but may be approximate and/or larger or smaller, as desired, reflecting tolerances, conversion factors, rounding off, measurement error and the like, and other factors known to those of skill in the art. In general, a dimension, size, formulation, parameter, shape or other quantity or characteristic is “about” or “approximate” whether or not expressly stated to be such. It is noted that embodiments of very different sizes, shapes and dimensions may employ the described arrangements.

Furthermore, the transitional terms “comprising”, “consisting essentially of” and “consisting of”, when used in the appended claims, in original and amended form, define the claim scope with respect to what unrecited additional claim elements or steps, if any, are excluded from the scope of the claim(s). The term “comprising” is intended to be inclusive or open-ended and does not exclude any additional, unrecited element, method, step, or material. The term “consisting of” excludes any element, step, or material other than those specified in the claim and, in the latter instance, impurities ordinary associated with the specified material(s). The term “consisting essentially of” limits the scope of a claim to the specified elements, steps, or material(s) and those that do not materially affect the basic and novel characteristic(s) of the claimed invention. All embodiments of the invention can, in the alternative, be more specifically defined by any of the transitional terms “comprising,” “consisting essentially of,” and “consisting of”.

### Compositions for Ring Closing Depolymerization

In one aspect, the disclosure provides a composition for ring closing depolymerization.

### Polymers

In some embodiments, the disclosure provides a composition for ring closing depolymerization comprising a polymer.

The compositions described herein may comprise a polymer having a low high ceiling temperature (T_{C}) or a high T_{C}. In general, the ceiling temperature (T_{C}) of a polymer may be defined as the temperature at which the free energy of polymerization (ΔF) is equal to zero (ΔF=ΔH−TΔS=0), i.e., T_{C}=ΔH/ΔS where ΔH equals the enthalpy of polymerization and AS equals the entropy of polymerization. The T_{C} of a polymer is also dependent on the monomer concentration and solvent. For most chain polymerizations, there is some temperature (T_{C}) above which the rate of the polymerization reaction is exceeded by the rate of the depolymerization reaction. Below T_{C}, polymerization will propagate but as the reaction temperature increases, there is reached a point T_{C} where the propagation rate constant equals the depropagation rate constant. Above T_{C}, depolymerization is thermally favored, the polymer becomes unstable and depolymerizes into its monomeric constituents.

The compositions described herein may comprise a polymer having a high T_{C}, for example, greater than or equal to about 100° C., greater than or equal to about 110° C., greater than or equal to about 120° C., greater than or equal to about 130° C., greater than or equal to about 140° C., greater than or equal to about 150° C., greater than or equal to about 160° C., greater than or equal to about 170° C., greater than or equal to about 180° C., greater than or equal to about 190° C., greater than or equal to about 200° C., greater than or equal to about 210° C., greater than or equal to about 220° C., greater than or equal to about 230° C., greater than or equal to about 240° C., greater than or equal to about 250° C., greater than or equal to about 300° C., greater than or equal to about 400° C., greater than or equal to about 500° C., greater than or equal to about 600° C., greater than or equal to about 700° C., or greater than or equal to about 800° C. In some embodiments, the T_{C} is greater than or equal to about 150° C. In some embodiments, the T_{C} is greater than or equal to about 200° C. In some embodiments the T_{C} is from about 100° C. to about 800° C., from about 100° C. to about 700° C., from about 100° C. to about 600° C., from about 100° C. to about 500° C., from about 100° C. to about 400° C., from about 100° C. to about 300° C., from about 100° C. to about 250° C., from about 110° C. to about 250° C., from about 120° C. to about 250° C., from about 130° C. to about 250° C., from about 140° C. to about 250° C., from about 150° C. to about 250° C., from about 160° C. to about 250° C., from about 170° C. to about 250° C., from about 180° C. to about 250° C., from about 190° C. to about 250° C., from about 200° C. to about 250° C., from about 100° C. to about 240° C., from about 100° C. to about 230° C., from about 100° C. to about 220° C., from about 100° C. to about 210° C., from about 100° C. to about 200° C., from about 100° C. to about 190° C., from about 100° C. to about 180° C., from about 100° C. to about 170° C., from about 100° C. to about 160° C., from about 100° C. to about 150° C., from about 150° C. to about 250° C., from about 150° C. to about 200° C., or from about 200° C. to about 250° C.

The compositions described herein may comprise the polymer at from about 1 wt % to about 99 wt % by weight of the composition, for example, about 1, about 5, about 10, about 15, about 20, about 25, about 30, about 35, about 40, about 45, about 50, about 55, about 60, about 65, about 70, about 75, about 80, about 85, about 90, about 95, or about 99 wt % by weight of the composition. In some embodiments, the polymer comprises about 70 wt % by weight of the composition. In some embodiments, the polymer comprises from about 10 wt % to about 90 wt %, from about 20 wt % to about 90 wt %, from about 30 wt % to about 90 wt %, from about 40 wt % to about 90 wt %, from about 50 wt % to about 90 wt % , from about 55 wt % to about 90 wt %, from about 60 wt % to about 90 wt %, from about 65 wt % to about 90 wt %, from about 70 wt % to about 90 wt %, from about 75 wt % to about 90 wt %, from about 80 wt % to about 90 wt %, from about 50 wt % to about 85 wt %, from about 50 wt % to about 80 wt %, from about 50 wt % to about 75 wt %, from about 50 wt % to about 70 wt %, from about 50 wt % to about 65 wt %, from about 50 wt % to about 60 wt %, from about 60 wt % to about 80 wt %, from about 60 wt % to about 70 wt %, from about 70 wt % to about 80 wt %, or from about 65 wt % to about 75 wt % by weight of the composition. In some embodiments, the polymer comprises from about 60 wt % to about 80 wt % by weight of the composition.

The compositions described herein may comprise any polymer known in the art synthesized by ring-opening polymerization. In some embodiments, the polymer is a polyester. In general, a polyester may be synthesized via ring-opening polymerization of cyclic esters (i.e., lactones). Examples of suitable polyesters include, but are not limited to, polylactic acid, poly(L-lactic acid), poly(D,L-lactic acid), poly(caprolactone), poly(ϵ-caprolactone), poly(pentadecalactone), poly(ω-pentadecalactone), poly(valerolactone), poly(δ-valerolactone), poly(ω-6-hexadecenelactone), poly(7-isopropyl-4-methyloxepan-2-one), poly(2,3-dihydro-5H-1,4-benzodioxepin-5-one), poly(1,5-dioxepan-2-one), poly(ϵ-decalactone), poly(ϵ-decalactone), poly(2-methyl-1,3-dioxan-4-one), poly(3-methyl-1,4-dioxan-2-one), poly(p-dioxanone), poly(δ-decalactone), poly(β-Methyl-δ-valerolactone), poly(δ-caprolactone), poly(α-propyl-δ-valerolactone), poly(trans-hexahydro-2(3H)-benzofuranone), poly(cis-hexahydro-2(3H)-benzofuranone), poly(γ-butyrolactone), poly(propiolactone), and poly(β-propiolactone). In some embodiments, the polymer comprises and/or consists of poly(caprolactone). In some embodiments, the polyester comprises and/or consists of poly(ϵ-caprolactone). In some embodiments, the polyester comprises and/or consists of poly(pentadecalactone). In some embodiments, the polyester comprises and/or consists of poly(ω-pentadecalactone). In some embodiments, the polyester comprises and/or consists of poly(valerolactone). In some embodiments, the polyester comprises and/or consists of poly(δ-valerolactone). In some embodiments, the polyester comprises and/or consists of polylactic acid. In some embodiments, the polyester comprises and/or consists of poly(L-lactic acid). In some embodiments, the polyester comprises and/or consists of poly(ω-6-hexadecenelactone). In some embodiments, the polyester is selected from poly(c-caprolactone), poly(ω-pentadecalactone), poly(δ-valerolactone), poly(L-lactic acid), and poly(ω-6-hexadecenelactone).

In some embodiments, the polymer is a polycarbonate. In general, a polycarbonate may be synthesized via ring-opening polymerization of cyclic carbonates. Examples of suitable polycarbonates include, but are not limited to, poly(trimethylene carbonate), poly(2,2-dimethyltrimethylene carbonate), poly(ethylene carbonate), poly(propylene carbonate) poly(1,3-dioxan-2-one), poly(5,5-dimethyl-1,3-dioxan-2-one), poly(5,5-diethyl-1,3-dioxan-2-one), poly(5-methyl-5-phenyl-1,3-dioxan-2-one), and poly(5-ethyl-5-phenyl-1,3-dioxan-2-one).

In some embodiments, the polymer comprises a mixture of polymers. In some embodiments, the polymer comprises a mixture of polyesters and polycarbonates. In some embodiments, the polymer comprises one or more polyesters (i.e., about 1, about 2, about 3, about 4, about 5, about 6, or more than about 6 polyesters). In some embodiments, the polymer comprises one or more polycarbonates (i.e., about 1, about 2, about 3, about 4, about 5, about 6, or more than about 6 polycarbonates). In some embodiments, the polymer comprises a mixture of one or more polyesters and one or more polycarbonates.

The polymer (e.g., polyester and/or polycarbonate) may be semi-crystalline and/or amorphous. In some embodiments, the polymer (e.g., polyester and/or polycarbonate) is semi-crystalline. In some embodiments, the polymer (e.g., polyester and/or polycarbonate) is amorphous.

The polymer (e.g., polyester and/or polycarbonate) is not limited to any particular molecular weight range. The molecular weight of a polymer can be described as a number average molecular weight (Mₙ) and/or a weight average molecular weight (M_{w}). The molecular weight can be measured by any method known to one of ordinary skill in the art, including, but not limited to, gel permeation chromatography (GPC) (i.e., size exclusion chromatography (SEC)) and nuclear magnetic resonance (NMR) spectroscopy. The polymer (e.g., polyester and/or polycarbonate) may have an Mₙ and/or M_{w} greater than about 1 kDa, greater than about 5 kDa, greater than about 10 kDa, greater than about 15 kDa, greater than about 20 kDa, greater than about 25 kDa, greater than about 30 kDa, greater than about 35 kDa, greater than about 40 kDa, greater than about 45 kDa, greater than about 50 kDa, or greater than about 100 kDa. In some embodiments, the Mₙ and/or M_{w} of the polymer (e.g., polyester and/or polycarbonate) is from about 1 kDa to about 1000 kDa, from about 10 kDa to about 1000 kDa, from about 50 kDa to about 1000 kDa, from about 100 kDa to about 1000 kDa, from about 10 kDa to about 100 kDa, from about 50 kDa to about 100 kDa, from about 1 kDa to about 100 kDa, from about 1 kDa to about 90 kDa, from about 1 kDa to about 80 kDa, from about 1 kDa to about 70 kDa, from about 1 kDa to about 60 kDa, from about 1 kDa to about 50 kDa, from about 10 kDa to about 90 kDa, from about 10 kDa to about 80 kDa, from about 10 kDa to about 70 kDa, from about 10 kDa to about 60 kDa, from about 10 kDa to about 50 kDa, from about 5 kDa to about 50 kDa, from about 20 kDa to about 50 kDa, from about 20 kDa to about 40 kDa, from about 10 kDa to about 90 kDa, from about 20 kDa to about 90 kDa, from about 30 kDa to about 90 kDa, from about 40 kDa to about 90 kDa, from about 50 kDa to about 90 kDa, from about 10 kDa to about 75 kDa, from about 20 kDa to about 75 kDa, from about 30 kDa to about 75 kDa, from about 40 kDa to about 75 kDa, from about 50 kDa to about 75 kDa, from about 50 kDa to about 100 kDa, from about 55 kDa to about 100 kDa, from about 60 kDa to about 100 kDa, from about 65 kDa to about 100 kDa, from about 50 kDa to about 95 kDa, from about 50 kDa to about 90 kDa, from about 50 kDa to about 85 kDa, about 50 kDa to about 80 kDa, from about 50 to about 150 kDa, from about 50 to about 200 kDa, from about 50 to about 300 kDa, from about 50 to about 500 kDa, from about 10 kDa to about 150 kDa, from about 10 kDa to about 100 kDa, about 10 kDa to about 200 kDa, from about 10 kDa to about 300 kDa, from about 10 kDa to about 400 kDa, from about 10 kDa to about 500 kDa, about 100 kDa to about 200 kDa, from about 100 kDa to about 300 kDa, from about 100 kDa to about 400 kDa, or from about 100 kDa to about 500 kDa.

The dispersity (Ð also referred to as “polydispersity index (PDI)”) of the polymer (e.g., polyester and/or polycarbonate) is not particularly limited. As used herein, dispersity is a dimensionless value, defined as Ð=M_{w}/Mₙ, wherein for a monodisperse polymer, Ð=1. In some embodiments, the polymer (e.g., polyester and/or polycarbonate) has a dispersity of from 1 to about 3, for example, 1, about 1.05, about 1.1, about 1.15. 1.2, about 1.25, about 1.3, about 1.35, about 1.4, about 1.45, about 1.5, about 1.55, about 1.6, about 1.65, about 1.7, about 1.75, about 1.8, about 1.85, about 1.9, about 1.95, about 2, about 2.5, or about 3. In some embodiments, the polymer (e.g., polyester and/or polycarbonate) has a dispersity of from 1 to about 3, from about 2 to about 3, from 1 to about 2, from 1 to about 1.9, from 1 to about 1.8, from 1 to about 1.7, from 1 to about 1.6, from 1 to about 1.5, from 1 to about 1.4, from 1 to about 1.3, from 1 to about 1.2, from 1 to about 1.1, from about 1.05 to about 2, from about 1.1 to about 2, from about 1.15 to about 2, from about 1.2 to about 2, from about 1.25 to about 2, from about 1.3 to about 2, from about 1.35 to about 2, from about 1.4 to about 2, from about 1.45 to about 2, from about 1.2 to about 1.3, or about 1.5 to about 2.

The compositions described herein may further comprise a monomer. In some embodiments, the monomer comprises a monomer of the polymer. For example, the monomer may be a reaction product of the ring closing depolymerization of the polymer. In some embodiments, the monomer comprises a monomer of a polyester, for example, a cyclic ester (i.e., a lactone). In some embodiments, the monomer comprises ϵ-caprolactone, δ-valerolactone, D,L-lactic acid, L-lactide, ω-pentadecalactone, 6-hexadecenelactone, β-Propiolactone, propiolactone, γ-Butyrolactone, trans-hexahydro-2(3H)-benzofuranone, cis-hexahydro-2(3H)-benzofuranone, α-propyl-δ-valerolactone, δ-caprolactone, β-Methyl-δ-valerolactone, δ-decalactone, p-dioxanone, 3-methyl-1,4-dioxan-2-one, 2-methyl-1,3-dioxan-4-one, ϵ-decalactone, ϵ-decalactone, 1,5-dioxepan-2-one, 2,3-dihydro-5H-1,4-benzodioxepin-5-one, 7-isopropyl-4-methyloxepan-2-one, 1,3-dioxan-2-one, 5,5-dimethyl-1,3-dioxan-2-one, 5,5-diethyl-1,3-dioxan-2-one, 5-methyl-5-phenyl-1,3-dioxan-2-one, and/or 5-ethyl-5-phenyl-1,3-dioxan-2-one. In some embodiments, the monomer comprises a monomer of a polycarbonate, for example, a cyclic carbonate. In some embodiments, the monomer comprises propylene carbonate and/or trimethylene carbonate.

In some embodiments, the monomer comprises a chiral carbon. In some embodiments, the monomer comprises an enantiomer. In some embodiments, the monomer comprises a mixture of enantiomers. In some embodiments, the mixture of enantiomers has an enantiomeric excess (ee) of at least about 50%, at least about 55%, at least about 60%, at least about 65%, at least about 70%, at least about 75%, at least about 80%, at least about 85%, at least about 90%, at least about 91%, at least about 92%, at least about 93%, at least about 94%, at least about 95%, at least about 96%, at least about 97%, at least about 98%, or at least about 99%. In some embodiments, the ee is at least 99%.

### Lewis Acids and Lewis Acid Catalysts

In one aspect, the disclosure provides a composition for ring closing depolymerization comprising a Lewis acid. In general, a Lewis acid is a substance which can accept a pair of electrons. In some embodiments, the Lewis acid is a Lewis acid catalyst.

In some embodiments, the Lewis acid and/or Lewis acid catalyst comprises a metal ion, for example, Al³⁺, Ga³⁺, In³⁺, Sn²⁺, Na⁺, K⁺, Be²⁺, Mg²⁺, and/or Ca²⁺. In some embodiments, the Lewis acid and/or Lewis acid catalyst comprises a transition metal, for example, titanium, vanadium, chromium, manganese, iron, cobalt, nickel, copper, zinc, zirconium, niobium, molybdenum, technetium, ruthenium, rhodium, palladium, silver, cadmium, hafnium, tantalum, tungsten, rhenium, osmium, iridium, platinum, gold, and/or mercury. In some embodiments, the Lewis acid and/or Lewis acid catalyst comprises iron. In some embodiments, the Lewis acid and/or Lewis acid catalyst comprises zinc. In some embodiments, the Lewis acid and/or Lewis acid catalyst comprises copper. In some embodiments, the Lewis acid and/or Lewis acid catalyst comprises zirconium. In some embodiments, the Lewis acid and/or Lewis acid catalyst comprises a transition metal ion, for example, Ti⁴⁺, Fe²⁺, Fe³⁺, Co²⁺, Co³⁺, Ni²⁺, Cu⁺, Cu²⁺, Zn²⁺, Zr⁴⁺, Ru²⁺, Pd²⁺, Ag⁺, Hf⁴⁺, Ir³⁺, Pt²⁺, and/or Au⁺. In some embodiments, the Lewis acid and/or Lewis acid catalyst comprises Zn²⁺. In some embodiments, the Lewis acid and/or Lewis acid catalyst comprises Zr⁴⁺. In some embodiments, the Lewis acid and/or Lewis acid catalyst comprises Cu²⁺. In some embodiments, the Lewis acid and/or Lewis acid catalyst comprises Fe²⁺. In some embodiments, the Lewis acid and/or Lewis acid catalyst comprises Fe³⁺.

In some embodiments, the Lewis acid and/or Lewis acid catalyst comprises an anion, for example, F⁻, Cl⁻, Br⁻, I⁻, Otf⁻, SO₃²⁻, SO₄²⁻, CO₃²⁻, PO₄³⁻, S²⁻, ClO₄⁻, NO₂⁻, NO₃⁻, CN⁻, SCN⁻, and/or S₂O₃²⁻.

In some embodiments, the Lewis acid and/or Lewis acid catalyst comprises ZnCl₂, Zn(Otf)₂, FeCl₃, FeCl₂, and/or ZrCl₄. In some embodiments, the Lewis acid and/or Lewis acid catalyst comprises ZnCl₂.

The compositions described herein may comprise the Lewis acid and/or Lewis acid catalyst at from about 1 wt % to about 99 wt % by weight of the composition, for example, about 1, about 2, about 3, about 4, about 5, about 6, about 7, about 8, about 9, about 10, about 11, about 12, about 13, about 14, about 15, about 16, about 17, about 18, about 19, about 20, about 25, about 30, about 35, about 40, about 45, or about 50 wt % by weight of the composition. In some embodiments, the comprise the Lewis acid and/or Lewis acid catalyst comprises about 5 wt % by weight of the composition. In some embodiments, the comprise the Lewis acid and/or Lewis acid catalyst comprises about 10 wt % by weight of the composition. In some embodiments, the comprise the Lewis acid and/or Lewis acid catalyst comprises about 15 wt % by weight of the composition. In some embodiments, the comprise the Lewis acid and/or Lewis acid catalyst comprises from about 1 wt % to about 50 wt %, from about 1 wt % to about 45 wt %, from about 1 wt % to about 40 wt %, from about 1 wt % to about 35 wt %, from about 1 wt % to about 30 wt %, from about 1 wt % to about 25 wt %, from about 1 wt % to about 20 wt %, from about 1 wt % to about 15 wt %, from about 1 wt % to about 10 wt %, from about 5 wt % to about 20 wt %, from about 10 wt % to about 20 wt %, from about 5 wt % to about 15 wt %, from about 9 wt % to about 11 wt %, or from about 7 wt % to about 13 wt % by weight of the composition. In some embodiments, the Lewis acid and/or Lewis acid catalyst comprises from about 1 wt % to about 20 wt % by weight of the composition. In some embodiments, the Lewis acid and/or Lewis acid catalyst comprises from about 5 wt % to about 15 wt % by weight of the composition.

The compositions described herein may comprise from about 0.01 to about 1 equivalents of the Lewis acid and/or Lewis acid catalyst per polymer repeat unit, for example, about 0.01, about 0.02, about 0.03, about 0.04, about 0.05, about 0.06, about 0.07, about 0.08, about 0.09, about 0.1, about 0.11, about 0.12, about 0.13, about 0.14, about 0.15, about 0.2, about 0.25, about 0.3, about 0.35, about 0.4, about 0.45, about 0.5, about 0.55, about 0.6, about 0.65, about 0.7, about 0.75, about 0.8, about 0.85, about 0.9, about 0.95, or about 1 equivalents of the Lewis acid and/or Lewis acid catalyst per polymer repeat unit. In some embodiments, the composition comprises about 0.08 equivalents of the Lewis acid and/or Lewis acid catalyst per polymer repeat unit. In some embodiments, the composition comprises about 0.1 equivalents of the Lewis acid and/or Lewis acid catalyst per polymer repeat unit. In some embodiments, the composition comprises about 0.11 equivalents of the Lewis acid and/or Lewis acid catalyst per polymer repeat unit. In some embodiments, the composition comprises from about 0.01 to about 1, from about 0.01 to about 0.5, from about 0.01 to about 0.4, from about 0.01 to about 0.3, from about 0.01 to about 0.2, from about 0.01 to about 0.1, from about 0.02 to about 1, from about 0.03 to about 1, from about 0.04 to about 1, from about 0.05 to about 1, from about 0.06 to about 1, from about 0.07 to about 1, from about 0.08 to about 1, from about 0.05 to about 0.5, from about 0.01 to about 0.1, or from about 0.01 to about 0.5 equivalents of the Lewis acid and/or Lewis acid catalyst per polymer repeat unit. In some embodiments, the composition comprises from about 0.05 to about 0.5 equivalents of the Lewis acid and/or Lewis acid catalyst per polymer repeat unit. In some embodiments, the composition comprises from about 0.01 to about 0.5 equivalents of the Lewis acid and/or Lewis acid catalyst per polymer repeat unit.

### Solvents

In one aspect, the disclosure provides a composition for ring closing depolymerization comprising a solvent. Generally, any solvent known to one of skill in the art can be used in accordance with the compositions and methods disclosed herein. The solvent may be aqueous (e.g., water and/or a buffer solution) or organic.

In some embodiments, the solvent comprises an ether, for example, diphenyl ether, 1,4-dioxane, diethyl ether, diethylene glycol dimethyl ether, methyl t-butyl ether, tetrahydrofuran, diisopropyl ether, and/or dibutyl ether. In some embodiments, the solvent comprises dibutyl ether.

In some embodiments, the solvent comprises a polyether, for example, poly(ethylene glycol) (PEG), tetraethylene glycol dimethyl ether (tetraglyme), poly(tetrahydrofuran) (p(THF)), poly(tetramethylene ether), poly(decamethylene ether), poly(hexadecamethylene ether), poly(propylene glycol), poly(butylene glycol), poly(pentylene glycol), poly(hexamethylene oxide), and/or poly(octamethylene oxide). In some embodiments, the solvent comprises PEG. The PEG may comprise any molecular weight of PEG, including but not limited to, PEG200, PEG300, PEG400, PEG600, PEG6000, PEG8000, PEG12000, and/or PEG20000. In some embodiments, the solvent comprises PEG600.

In some embodiments, the solvent comprises an alcohol, for example, methanol, ethanol, isopropanol, n-propanol, 1-butanol, 2-butanol, tert-butanol, benzyl alcohol, cyclohexanol, ethylene glycol, 1,2-propanediol, 1,3-propanediol, 1,3-butanediol, 1,4-butanediol, 1,2-pentanediol, 1,5-pentanediol, 1,2-hexanediol, 1,6-hexanediol, 1,2-heptanediol, 1,7-heptanediol, 1,2-octanediol, 1,8-octanediol, and/or glycerol. In some embodiments, the solvent comprises ethylene glycol. In some embodiments, the solvent comprises 1,6-hexanediol. In some embodiments, the solvent comprises 1,5-pentanediol. In some embodiments, the solvent comprises glycerol. In some embodiments, the solvent comprises 1,8-octanediol.

In some embodiments, the solvent comprises an alkane, for example, hexane, heptane, octane, and/or eicosane. In some embodiments, the solvent comprises a C₆₋₃₀ linear or branched alkane. In some embodiments, the solvent comprises eicosane.

### Methods

In one aspect, the disclosure provides methods for chemical recycling in which the polymer is chemically transformed back into its constituent monomer. These methods avoid problems with impurities introduced during polymer use and reprocessing, and developing chemoselective depolymerization methods addresses the mixed polymer waste problem.

In some embodiments, the disclosure provides a method for ring closing depolymerization. In some embodiments, the method comprises mixing a reaction composition comprising a polymer, a Lewis acid, and a solvent. Components of the reaction mixture such as polymers, Lewis acids, and solvents suitable for the methods are described in detail herein.

In some embodiments, the disclosure provides a chemically recycled composition made by the methods provided herein. In some embodiments, the chemically recycled composition comprises a monomer. In some embodiments, the monomer comprises a monomer of the polymer, (e.g., a reaction product of the ring closing depolymerization of the polymer). In some embodiments, the monomer comprises a monomer of a polyester, for example, a cyclic ester (i.e., a lactone). In some embodiments, the monomer comprises c-caprolactone, 6-valerolactone, D,L-lactic acid, L-lactide, co -pentadecalactone, and/or 6-hexadecenelactone. In some embodiments, the monomer comprises a monomer of a polycarbonate, for example, a cyclic carbonate. In some embodiments, the monomer comprises propylene carbonate and/or trimethylene carbonate.

### Heating

The methods described herein may comprise heating (i.e., applying heat to) the reaction composition. Heat can be applied to the reaction composition by any method known to one of ordinary skill in the art, such as by a heating element, a microwave, or a flame.

The high temperatures (e.g., >200° C.) often used for depolymerization reactions result in unselective depolymerization reactions. For example, L-lactide (LLA) production involves the oligomerization of lactic acid followed by Lewis-acid catalyzed, ring-closing depolymerization at high temperatures of >200° C. Unwanted side reactions, such as decarboxylation, dehydration, and epimerization are problematic at high conversion and when using higher molecular weight poly(L-lactic acid) (PLLA).

In some embodiments, heating comprises a temperature less than or equal to the T_{C} of the polymer under similar conditions (e.g., monomer concentration, solvent, etc.). In some embodiments, heating comprises a temperature less than the T_{C} of the polymer under similar conditions (e.g., monomer concentration, solvent, etc.). In some embodiments, heating comprises a temperature significantly less (e.g., from about 10° C. to about 800° C. less) than the T_{C} of the polymer under similar conditions (e.g., monomer concentration, solvent, etc.).

In some embodiments, heating comprises a temperature greater than about 50° C., greater than about 60° C., greater than about 70° C., greater than about 80° C., greater than about 90° C., greater than about 100° C., greater than about 110° C., greater than about 120° C., greater than about 130° C., greater than about 140° C., or greater than about 150° C. In some embodiments, heating comprises a temperature of from about 50° C. to about 250° C., for example, about 50, about 60, about 70, about 80, about 90, about 100, about 110, about 120, about 130, about 140, about 150, about 160, about 170, about 180, about 190, about 200, about 210, about 220, about 230, about 240, or about 250° C. In some embodiments, heating comprises a temperature of about 160° C. In some embodiments, heating comprises a temperature of from about 50° C. to about 200° C., from about 60° C. to about 200° C., from about 70° C. to about 200° C., from about 80° C. to about 200° C., from about 90° C. to about 200° C., from about 100° C. to about 200° C., from about 110° C. to about 200° C., from about 120° C. to about 200° C., from about 130° C. to about 200° C., from about 140° C. to about 200° C., from about 150° C. to about 200° C., about 160° C. to about 200° C., from about 100° C. to about 190° C., from about 100° C. to about 180° C., from about 100° C. to about 170° C., from about 100° C. to about 160° C., from about 125° C. to about 175° C., from about 140° C. to about 180° C., or from about 150° C. to about 170° C. In some embodiments, heating comprises a temperature of about 100° C. to about 200° C. In some embodiments, heating comprises a temperature of about 140° C. to about 180° C. In some embodiments, heating comprises a temperature of about 150° C. to about 170° C.

### Pressure

The methods described herein may further comprise reducing a pressure (e.g., by applying a vacuum) of the reaction composition. In some embodiments, the pressure is less than 1 atm. In some embodiments, the pressure is less than about 760 torr, less than about 500 torr, less than about 100 torr, less than about 50 torr, less than about 10 torr, less than about 5 torr, less than about 1 torr, less than about 0.5 torr, or less than about 0.1 torr. In some embodiments, the pressure is from about 0.001 torr to about 100 torr, for example, about 0.001, about 0.005, about 0.01, about 0.05, about 0.1, about 0.5, about 1, about 5, about 10, about 50, or about 100 torr. In some embodiments, the pressure is about 0.1 torr. In some embodiments, the pressure is from about 0.01 torr to about 1.5 torr, from about 0.05 torr to about 1.5 torr, from about 0.01 torr to about 1.0 torr, from about 0.01 torr to about 0.5 torr, from about 0.01 torr to about 0.1 torr, from about 0.05 torr to about 0.5 torr, from about 0.05 torr to about 0.4 torr, from about 0.05 torr to about 0.3 torr, from about 0.05 torr to about 0.2 torr, from about 0.05 torr to about 0.1 torr, from about 0.1 torr to about 0.5 torr, from about 0.075 torr to about 0.15 torr, or from about 0.05 torr to about 0.15 torr. In some embodiments, the pressure is from about 0.01 torr to about 1 torr.

### Reactive Distilling

In order to depolymerize polymers (e.g., polymers with moderate to high TO under relatively mild conditions, the thermodynamic preference for polymerization must be circumvented; for example, by carrying out the depolymerization reactions under reactive distillation conditions, which prevents the polymer/monomer equilibrium from being established by removing the monomer as soon as it is formed. In order to achieve efficient depolymerization by reactive distillation, the rate of the depolymerization and the rate of removing the monomer must be balanced so that subsequent ring opening of the cyclic monomer is minimized.

As used herein, the term “reactive distilling” refers to any distillation process in which at least one type of chemical reaction occurs. The term “distillation” as used herein includes any process in which components (or materials) in a composition for distillation are separated into various fractions having different boiling point ranges or other properties. The boiling point ranges for the various fractions may overlap each other. After separation, these fractions may be in the form of vapors, gases, supercritical fluids, liquids, solids, or mixtures thereof, such as pastes, slurries, and composites.

The methods described herein may further comprise reactive distilling the reaction composition. In some embodiments, the reactive distilling may be performed more than one time, for example, about 1, about 2, about 3, about 4, about 5 times, or more than about 5 times. In some embodiments, the reactive distilling is performed about 1 time.

The reactive distilling may comprise a chemical reaction, for example, ring closing depolymerization of the polymer. In some embodiments, the reaction composition comprises a reaction product (e.g., a monomer). In some embodiments, the reactive distilling comprises removing a reaction product (e.g., a monomer) from the reaction composition. In some embodiments, a distillate of the reactive distilling comprises the reaction product (e.g., a monomer). In some embodiments, the reaction product comprises a monomer, for example, a monomer of the polymer as described herein.

In some embodiments, the monomer (e.g., a monomer of the polymer) has a purity of at least about 10%, at least about 20%, at least about 30%, at least about 40%, at least about 50%, at least about 60%, at least about 70%, at least about 75%, at least about 80%, at least about 85%, at least about 90%, at least about 91%, at least about 92%, at least about 93%, at least about 94%, at least about 95%, at least about 96%, at least about 97%, at least about 98%, or at least about 99%. In some embodiments, the monomer is at least about 99%. In some embodiments, the purity is measured by qNMR.

In some embodiments, the reactive distilling is performed for from about 1 hour to about 70 hours, for example, about 1, about 2, about 3, about 4, about 5, about 6, about 7, about 8, about 9, about 10, about 11, about 12, about 13, about 14, about 15, about 16, about 17, about 18, about 19, about 20, about 21, about 22, about 23, about 24, about 25, about 30, about 35, about 40, about 45, about 50, about 55, about 60, about 65, about 66, or about 70 hours. In some embodiments, the reactive distilling is performed for about 16 hours. In some embodiments, the reactive distilling is performed from about 1 hour to about 50 hours, from about 1 hours to about 40 hours, from about 1 hours to about 30 hours, from about 1 hours to about 20 hours, from about 10 hours to about 50 hours, from about 20 hours to about 50 hours, from about 10 hours to about 24 hours, from about 10 hours to about 22 hours, from about 10 hours to about 20 hours, from about 10 hours to about 18 hours, from about 10 hours to about 16 hours, from about 12 hours to about 24 hours, from about 14 hours to about 24 hours, from about 16 hours to about 24 hours, from about 15 hours to about 17 hours, or from about 14 hours to about 18 hours.

In some embodiments, during the reactive distilling, the Mₙ and/or M_{w} of the polymer decreases. In some embodiments, the Mₙ and/or M_{w} of the polymer decreases by at least about 10%, at least about 20%, at least about 30%, at least about 40%, at least about 50%, at least about 60%, at least about 70%, at least about 75%, at least about 80%, at least about 85%, at least about 90%, at least about 91%, at least about 92%, at least about 93%, at least about 94%, at least about 95%, at least about 96%, at least about 97%, at least about 98%, or at least about 99%. In some embodiments, following the reactive distilling, the Mₙ and/or M_{w} of the polymer decreases. In some embodiments, the Mₙ and/or M_{w} of the polymer decreases by at least about 10%, at least about 20%, at least about 30%, at least about 40%, at least about 50%, at least about 60%, at least about 70%, at least about 75%, at least about 80%, at least about 85%, at least about 90%, at least about 91%, at least about 92%, at least about 93%, at least about 94%, at least about 95%, at least about 96%, at least about 97%, at least about 98%, or at least about 99%.

In some embodiments, during the reactive distilling, the dispersity of the polymer increases. In some embodiments, the dispersity of the polymer increases at least about 1%, at least about 5%, at least about 10%, at least about 15%, at least about 20%, at least about 25%, at least about 30%, at least about 35%, at least about 40%, at least about 45%, at least about 50%, at least about 55%, at least about 60%, at least about 65%, at least about 70%, at least about 75%, at least about 80%, at least about 85%, or at least about 90%. In some embodiments, following the reactive distilling, the dispersity of the polymer increases. In some embodiments, the dispersity of the polymer increases at least about 1%, at least about 5%, at least about 10%, at least about 15%, at least about 20%, at least about 25%, at least about 30%, at least about 35%, at least about 40%, at least about 45%, at least about 50%, at least about 55%, at least about 60%, at least about 65%, at least about 70%, at least about 75%, at least about 80%, at least about 85%, or at least about 90%.

In some embodiments, following the reactive distillation, at least about 10%, at least about 20%, at least about 30%, at least about 40%, at least about 50%, at least about 60%, at least about 70%, at least about 75%, at least about 80%, at least about 85%, at least about 90%, at least about 91%, at least about 92%, at least about 93%, at least about 94%, at least about 95%, at least about 96%, at least about 97%, at least about 98%, or at least about 99% of the monomer is isolated.

In some embodiments, following the reactive distilling, less than about 90%, less than about 80%, less than about 70%, less than about 60%, less than about 50%, less than about 40%, less than about 30%, less than about 25%, less than about 20%, less than about 15%, less than about 10%, less than about 9%, less than about 8%, less than about 7%, less than about 6%, less than about 5%, less than about 4%, less than about 3%, less than about 2%, or less than about 1% of the polymer is remaining.

While preferred embodiments of the invention are shown and described herein, such embodiments are provided by way of example only and are not intended to otherwise limit the scope of the invention. Various alternatives to the described embodiments of the invention may be employed in practicing the invention.

### EXAMPLES

The embodiments encompassed herein are now described with reference to the following examples. These examples are provided for the purpose of illustration only and the disclosure encompassed herein should in no way be construed as being limited to these examples, but rather should be construed to encompass any and all variations which become evident as a result of the teachings provided herein.

### Example 1: A Simple, Selective, and General Catalyst for Ring Closing Depolymerization of Polyesters and Polycarbonates for Chemical Recycling

The ability to efficiently and selectively process mixed polymer waste is important to address the growing plastic waste problem.

Herein, the combination of ZnCl₂ and an additive amount of poly(ethylene glycol) under vacuum is reported to readily and selectively depolymerize polyesters and polycarbonates with high ceiling temperatures (T_{c}>200° C.) back to their constitute monomers. Mechanistic experiments implicate a random chain scission mechanism and a catalyst structure containing one equivalent of ZnCl₂ per ethylene glycol repeat unit in the poly(ethylene glycol). In addition to being general for a wide variety of polyesters and polycarbonates, the catalyst system could selectively depolymerize a polyester in the presence of other commodity plastics, demonstrating how reactive distillation using the ZnCl₂/PEG600 catalyst system can be used to separate mixed plastic waste.

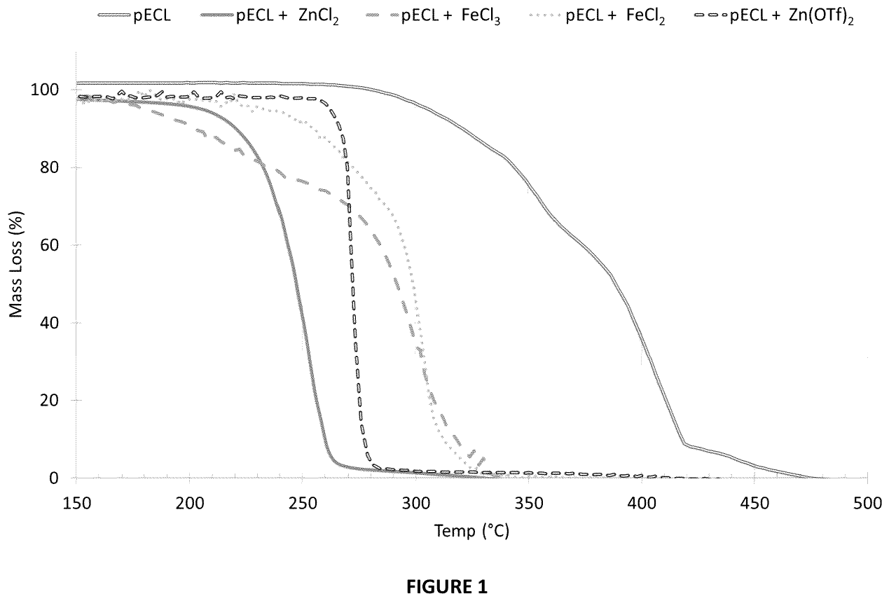

In order to rapidly screen a variety of Lewis acid catalysts, it was reasoned that the dynamic flow in a thermogravimetric analysis (TGA) experiment would mimic the non-equilibrium environment of a reactive distillation reaction, but that could be set up on a small scale and with higher throughput. Therefore, using TGA under nitrogen flow, number of simple Lewis acid catalysts were screened for the depolymerization of poly(ε-caprolactone) (pECL), which has a T_{C}=261° C. (FIG. 1). Comparing the onset degradation temperature (T_{d5%}), defined as the temperature at 5% mass loss, and the final degradation temperature (T_{d95%}), defined as the temperature at 95% mass loss, the effect of different simple Lewis acid catalysts on degradation was examined. Thermal degradation without catalyst had the highest T_{d5%} and T_{d95%} (305° C. and 441° C., respectively) compared to degradation in the presence of Lewis acids. Of the Lewis acids evaluated, ZnCl₂ had the second lowest T_{d5%} (203° C.) and the lowest Td95% (262° C.). Consequently, ZnCl₂ was selected as the catalyst for further optimization.

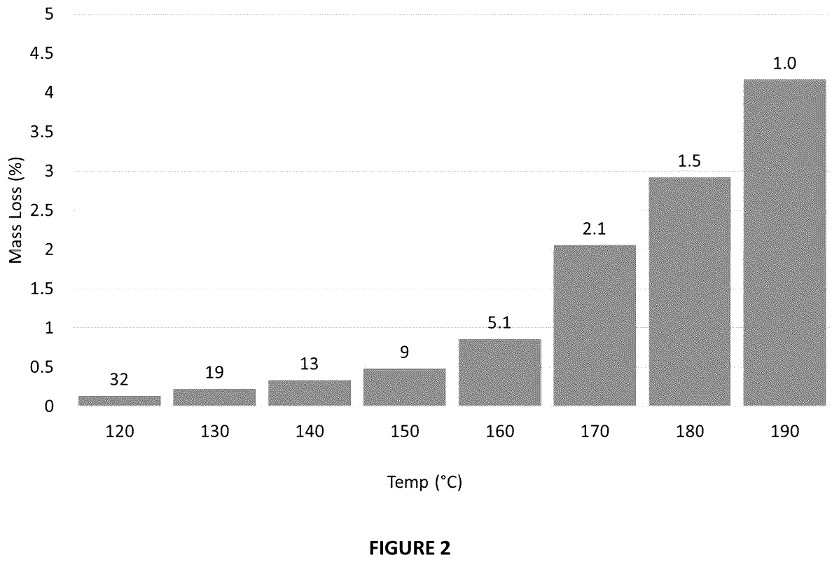

Next, a stepped isothermal TGA experiment was used to identify the optimal temperature for depolymerization. In this experiment, pECL and ZnCl₂ was heated from 100° C. to 210° C., stopping every 10° C. for 30 min. to follow mass loss at each temperature. The data obtained from this experiment is shown in FIG. 2 along with the estimated half-life assuming the degradation follows first-order kinetics. The depolymerization reactions were aimed to be carried out at the lowest temperature that was practical for depolymerization to conserve energy and to minimize background reactions that may occur at elevated temperatures. Therefore, 160° C. was selected for further screening and optimization because it was estimated that the reactive distillation would be >85% complete after 15 h.

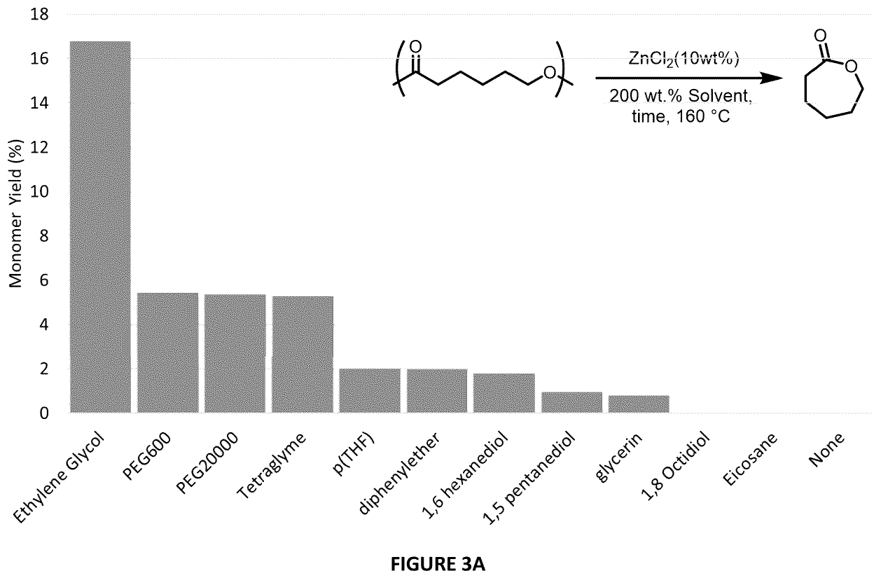

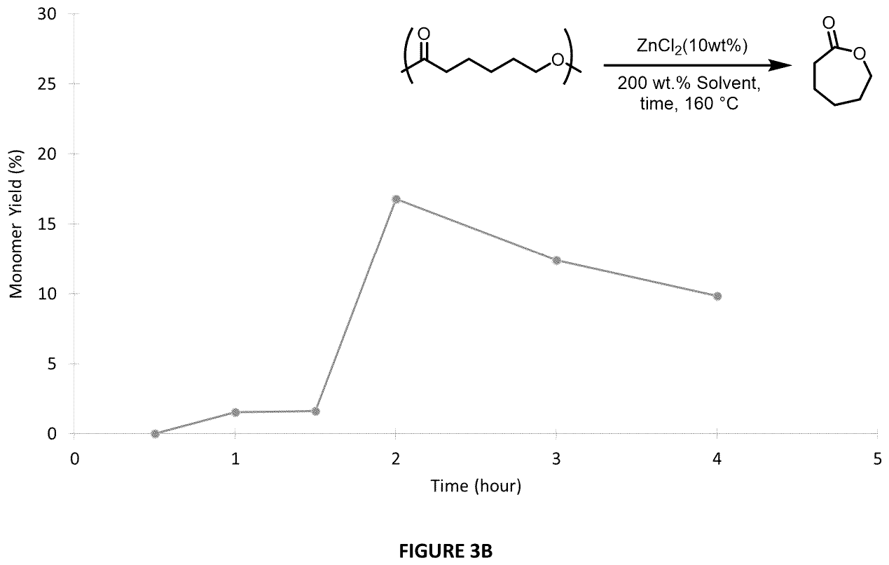

Recently, solvent identity has shown have a large effect on the T_{c} of polymers in solution depolymerization reactions. To assess whether solvent could be beneficial for depolymerization using ZnCl₂, a range of readily accessible high boiling solvents were screened, and attempted to depolymerize pECL under dilute reaction conditions at atmospheric pressure (FIG. 3A). While none of the solvents resulted in high yields of ε-caprolactone (ECL), polar, coordinating solvents gave significantly higher yields than the non-polar solvent eicosane, which did not produce any monomer. Of the polar solvents studied, monomer yield was highest using ethylene glycol (EG) as the solvent. Proton nuclear magnetic resonance spectroscopy (¹H NMR) analysis of a reaction mixture that was heated for 2 h using EG as the solvent revealed a mixture of monomer, polymer, linear oligomers, and cyclic oligomers. Importantly, solvent incorporation into the polymer was not observed by NMR, which suggested that EG was not initiating transesterification reactions. Notably, solvents that contained EG repeat units (e.g., polyethene glycol (PEG) and tetraglyme) produced ECL in higher yields than other polyol solvents that contained more methylene spacers between the oxygen atoms (e.g., poly(tetrahydrofuran) (pTHF) and 1,8-octanediol). These results suggested that the EG had an additional role other than being a solvent for the depolymerization reaction (vide supra).

Next, a time course experiment in EG was carried out to better understand why the depolymerization reactions in solution did not produce ECL in high yields (FIG. 3B). During this experiment, ECL yield was initially low and then peaked at 2 h. At longer reaction times, ECL yield plateaued and then started to decrease. One hypothesis to explain this behavior is that initial depolymerization to ECL occurs in the first 2 h. At this point, significant build-up of monomer starts to undergo ring opening polymerization to form a mixture of ECL oligomers. Since the temperature of the reaction is below T_{C} for pECL, the reaction reaches an equilibrium that favors short chained oligomers. Repeating the experiment under more dilute conditions would likely lead to more ECL, but dilution is impractical and unworkable at the scale that would be needed to efficiently recycle commercial polymers.

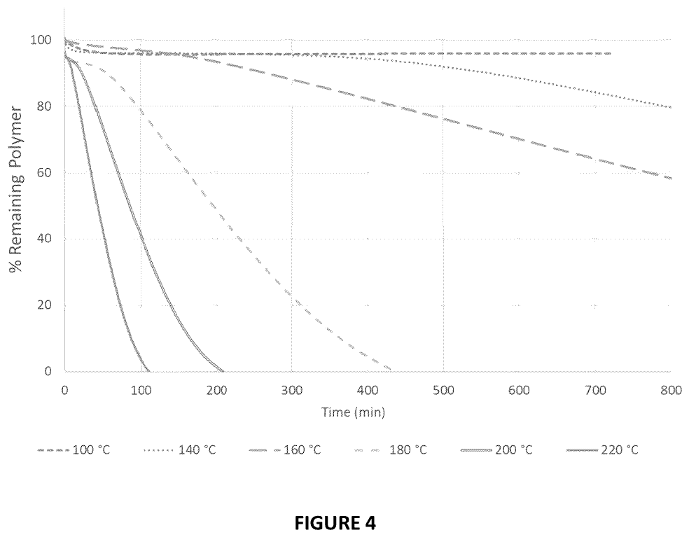

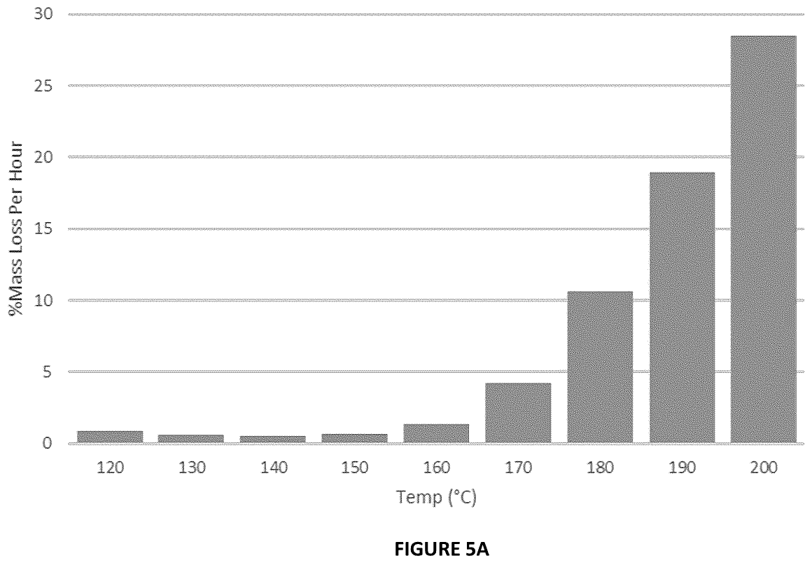

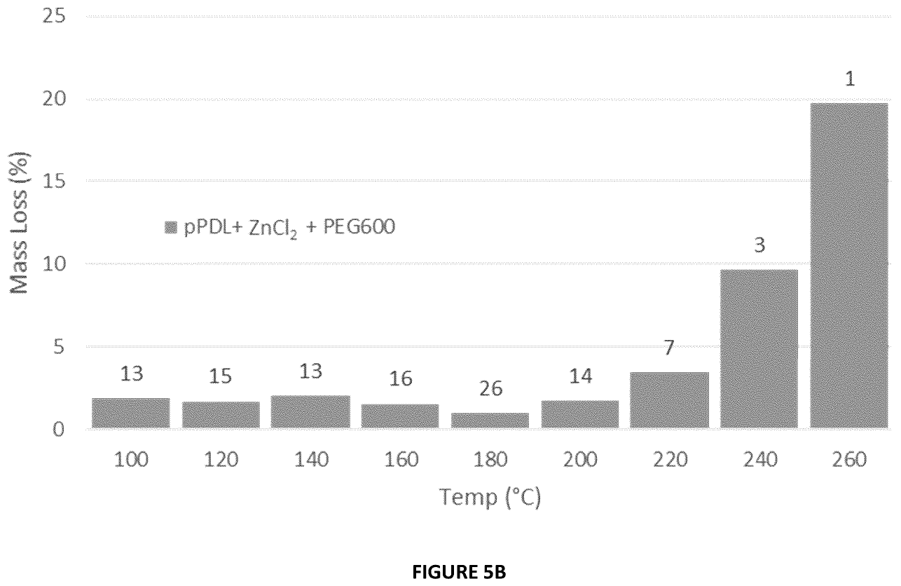

Instead, reactive distillation was explored as an alternative to depolymerize pECL below its T_{C}. In order to achieve efficient depolymerization by reactive distillation, the rate of the depolymerization and the rate of removing the monomer must be balanced so that subsequent ring opening of the cyclic monomer is minimized. Fortunately, this requirement was already demonstrated in the initial TGA screening reactions where mass loss was observed at temperatures below the T_{C} of the pECL (FIG. 1). In order to best mimic the TGA experiments and to take advantage of the beneficial effects of using a polar additive that were discovered in the solution depolymerization reactions, it was hypothesized that a high boiling additive with a low vapor pressure would be needed to carrier out these reactions. Consequently, PEG was chosen as the polar additive because it retains the EG repeat unit that was found to be beneficial for depolymerization while having a tunable boiling point that could be achieved by varying the PEG molecular weight (e.g., PEG600, PEG20000, etc.). Based on experiments carried out with PEG600 in a stepped isothermal TGA (FIG. 4), the optimal conditions were determined for reactive distillation (i.e., 160° C., 10 wt % ZnCl₂, 100 wt % PEG600). Reactive distillation was next carried out by under a 0.1 Torr vacuum (Table 1). Consistent with the TGA experiments and counter to results obtained from depolymerization reactions carried out in solution, the reactive distillation resulted in full depolymerization of pECL with quantitative recovery of ECL after 20 h (entry 1). Control reactions without PEG600 (entry 2) or ZnCl₂ (entry 3) resulted in no mass loss, and no ECL recovery. That the depolymerization did not occur efficiently in the absence of PEG600 under these conditions but did occur in the TGA experiment is likely a consequence of more efficient monomer removal in the TGA experiment compared to the reactive distillation. Lowering the temperature to 140° C. resulted in significantly lower yields after 16 h (entry 4), but full recovery of the monomer could be achieved at 140° C. by extending the reaction time to 66 h (entry 5). Lowering the temperature further to 120° C. showed poor ECL recovery even at extended reaction times (entry 6). These results are consistent with the isothermal TGA experiments, which showed no mass loss at temperatures below 140° C. (FIG. 5A-B). To evaluate whether PEG600 was required in solvent quantities, less PEG600 was added to the reaction (entries 7 and 8). These reactions revealed that efficient depolymerization could be achieved even when PEG600 was used in additive amounts.

TABLE 1
Optimization for the depolymerization of
pECL catalyzed by ZnCl₂/PEG600.

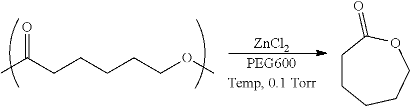

| | | | | | Mass | | |
|---|---|---|---|---|---|---|---|
| | | | | | Bal- | Remaining | Isolated |
| En- | Temp | Time | ZnCl₂ | PEG600 | ance | Polymer | Monomer |
| try | (° C) | (h) | equiv | wt. % | (%) | (%) | (%) |
| 1 | 160 | 20 | 0.08 | 117 | 95 | 0 | 101 |
| 2 | 160 | 16 | 0 | 100 | 100 | 100 | 0 |
| 3 | 160 | 16 | 0.08 | 0 | 99 | 98 | 0 |
| 4 | 140 | 16 | 0.08 | 130 | 98 | 86 | 9 |
| 5 | 140 | 66 | 0.08 | 121 | 96 | 0 | 99 |
| 6 | 120 | 66 | 0.11 | 120 | 101 | 97 | 3 |
| 7 | 160 | 16 | 0.08 | 20 | 98 | <1 | 96 |
| 8 | 160 | 16 | 0.10 | 11 | 91 | 2 | 87 |

ZnCl₂ equiv. based on pECL repeat unit. PEG600 wt % based on polymer mass.

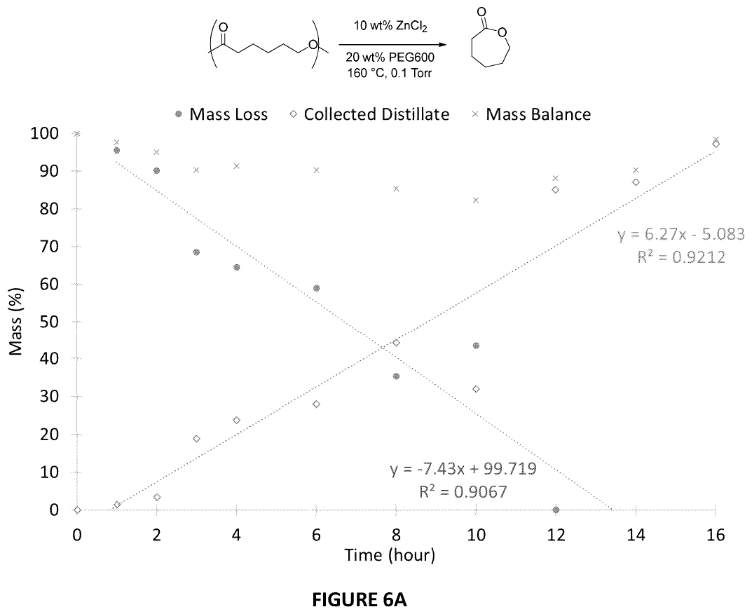

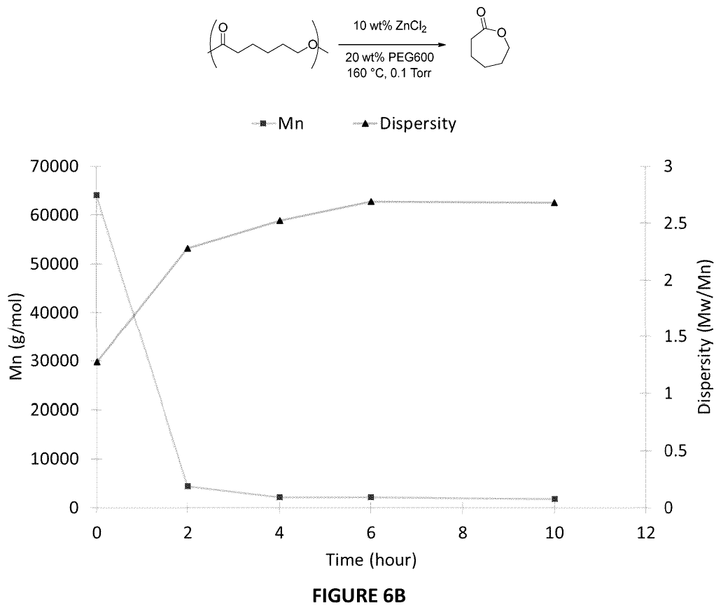

With respect to reaction mechanism, two different depolymerization mechanisms were considered: 1) chain end unzipping, where depolymerization occurs from one chain end to the other, and 2) random chain scission followed by cyclization, where the polymer backbone is broken throughout the polymer resulting in shorter chains that then undergo monomer formation. In order to distinguish these two mechanisms, a reactive distillation was conducted using an additive amount of PEG600 at different reaction times and analyzed the remaining polymer residue by gel permeation chromatograph (GPC). This experiment revealed a roughly linear decrease in pECL mass over time that correlated with a similar increase in ECL yield (FIG. 6A). Moreover, polymer analysis revealed a rapid decrease in molecular weight and an increase in dispersity as the reaction proceeded (FIG. 6B). These results are more consistent with a random chain scission process rather than chain end unzipping for depolymerization, which would result in a linear decrease in molecular weight occurring without much broadening of the molecular weight distribution as the reaction progressed. A random chain scission mechanism also helps explain the induction period that is observed in the isothermal TGA (FIG. 4): no polymer mass loss is expected until after polymer chain scission occurs extensively enough to form the monomer.

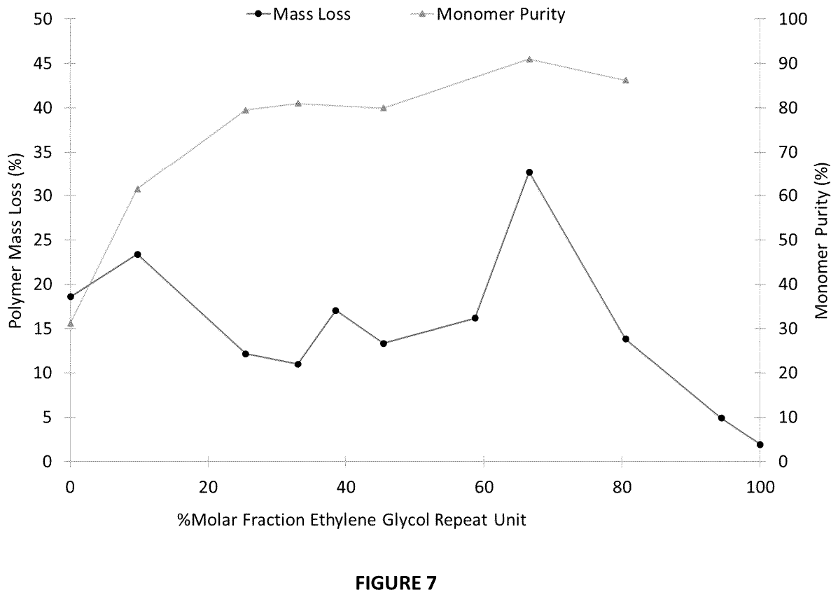

In addition to the mechanism for depolymerization, there was interest in understanding better what role PEG had in the depolymerization reactions. Results from the solvent screen (FIG. 3A) and the ability to carry out effective reactive distillations at low PEG loadings (entries 7-8, Table 1) suggested that the PEG additive served a role other than a solvent. One possible role for PEG is that it serves as a ligand for ZnCl_{2 ,} which is the active form of the catalyst. Unfortunately, efforts to isolate a complex between PEG-600 and ZnCl₂ have been unsuccessful. Nevertheless, in order to determine the optimal stoichiometry of EG repeat unit relative to the ZnCl₂ that led to the best conditions for depolymerization, reactions were carried out at different mole fractions of PEG-600 and ZnCl₂ (FIG. 7). Results from these experiments revealed a peak in polymer mass loss that occurred at 2:1 ratio of EG repeat unit in PEG600 to ZnCl₂. Additionally, while mass loss is observed when no PEG600 is present with very high ZnCl₂ loading, the depolymerization is no longer selective for ECL. This experiment suggests that the highest catalytic activity from this system occurs when two oxygen atoms from PEG are bound to one zinc. Importantly, while the optimal relative EG/ZnCl₂ stoichiometry can be determined from this experiment, it does not reveal the number of zinc complexes required for chain scission to occur. Overall, the mechanistic experiments suggest that PEG enables efficient and selective depolymerization of pECL by binding to ZnCl₂ to form a particularly effective catalyst that proceeds by a random chain scission mechanism.

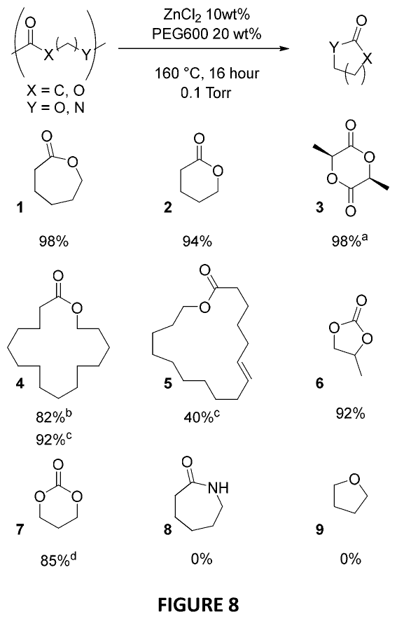

Next, the generality of the system was explored by carrying out the depolymerization of other polymers (FIG. 8). Poly(δ-valerolactone) and PLLA could be efficiently depolymerized under the standard reaction conditions to recover 2 and 3, respectively. Notably, PLLA depolymerized with minimal epimerization as 3 was recovered in 99.4% ee and with only 2% of meso-lactide. To test the limit of the depolymerization method, poly(ω-pentadecalactone) (pPDL) depolymerization was explored. pPDL is interesting because it has properties similar to high density polyethylene. Additionally, ω-pentadecalactone (4) is unusual because its polymerization is enthalpically disfavored but entropically favored. Consequently, the most stable molecule derived from 4 polymerizations is its cyclic dimer. Consistent with these thermodynamic properties, depolymerization of pPDL under our standard conditions led to the cyclic dimer of 4 as the primary product. Guided once again by stepped isothermal TGA experiments, the reactive distillation temperature was raised to 210° C., which led to nearly complete degradation of the polymer and high 4 yields. In addition to pPDL, the polymer derived from the unsaturated macrolactone 6-hexadecenelactone (5) could be depolymerized at 210° C., albeit in lower yields.

The ZnCl₂/PEG-600 catalyst system was also suitable for the depolymerization of polycarbonates derived from cyclic monomers. Poly(propylene carbonate) and poly(trimethylcarbonate) could be depolymerized to give excellent yield of 6 and 7, respectively. However, the catalyst system was not suitable for the depolymerization of some classes of monomers. Polyamide nylon-6 did not depolymerize to form 8 under these conditions, and surprisingly, pTHF did not depolymerize to THF 9 despite Lewis acids being known catalysts for pTHF depolymerization.

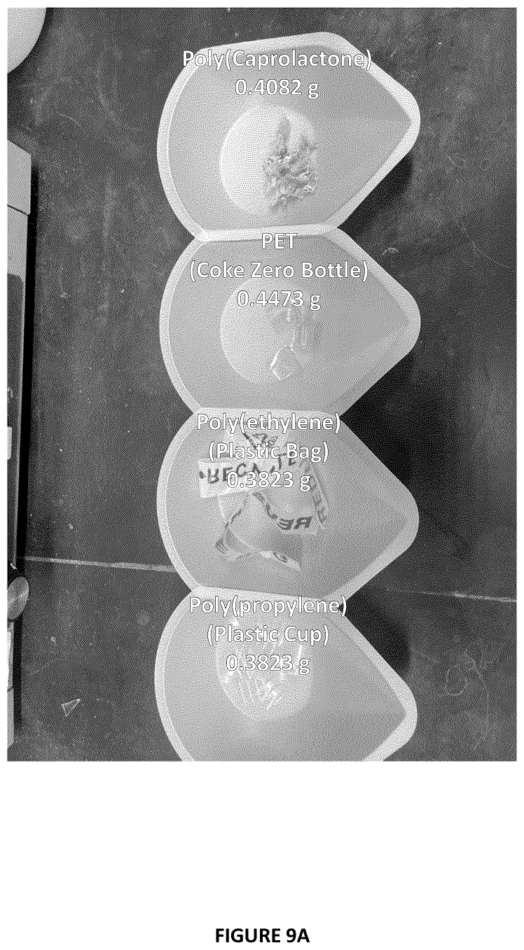

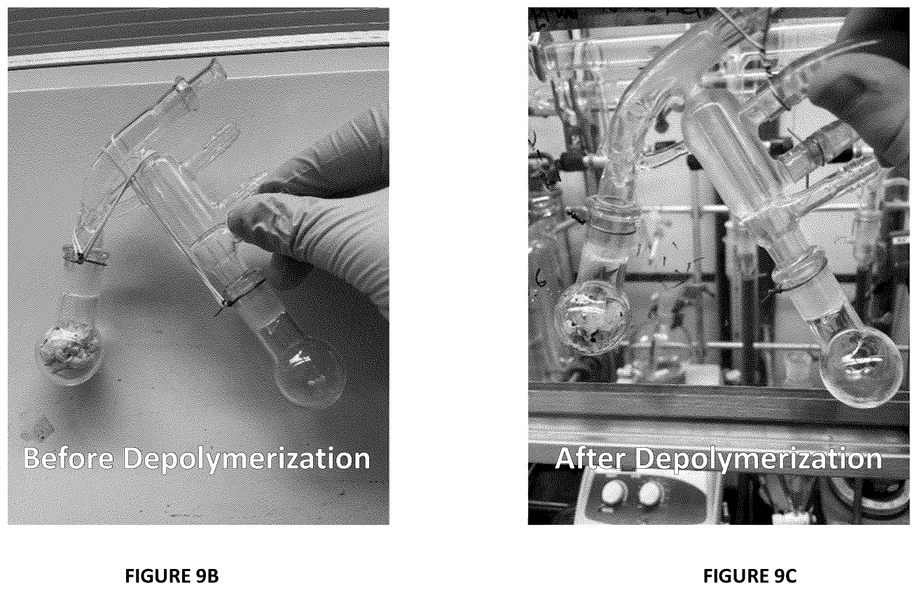

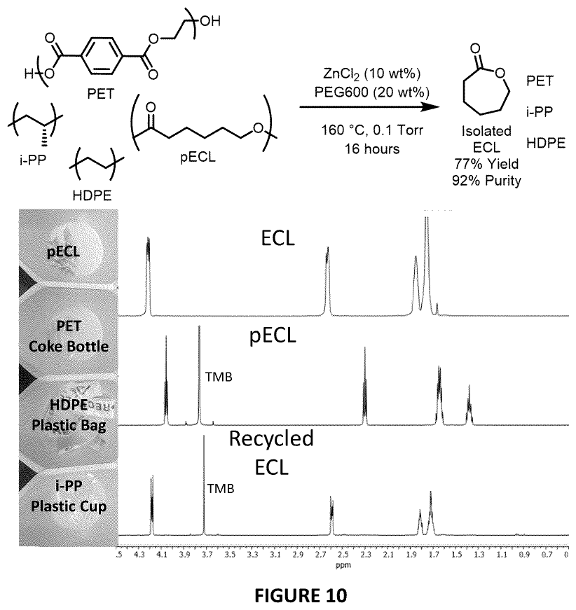

Finally, the sensitivity of the depolymerization catalyst was evaluated to common impurities that may be present in polymer waste. Therefore, the depolymerization was carried out by combining pECL with equal amounts of post-consumer poly(ethylene terephthalate) (PET), isotactic poly(propylene) (i-PP), and linear low density poly(ethylene) (LLDPE) (FIG. 9A-C and FIG. 10). Under the standard reactive distillation conditions, selective depolymerization of the pECL occurred leading to isolation of ECL in 77% yield (97% mass balance). The ECL in the distillate was very pure (92%), only slightly lower than what was obtained when pure pECL was used in the depolymerization reaction (>98%).

In conclusion, it was demonstrated that a simple catalyst system that is efficient and selective to depolymerize high T_{C} polyesters and polycarbonates (153° C.<T_{C}<261° C.) under reactive distillation conditions, including stereoretentive PLLA depolymerization and depolymerization of macrolactones. Mechanistic studies revealed that the depolymerization process occurs by a random chain scission mechanism involving an active catalyst species that contains one ZnCl₂ to one EG unit in PEG600. Additionally, pECL depolymerization in the presence of other commodity plastics was possible. These findings demonstrate how carrying out depolymerization reactions with the appropriate catalyst under the non-equilibrium conditions of reactive distillation enables depolymerization reactions that occur significantly below the T_{C} of the polymer.

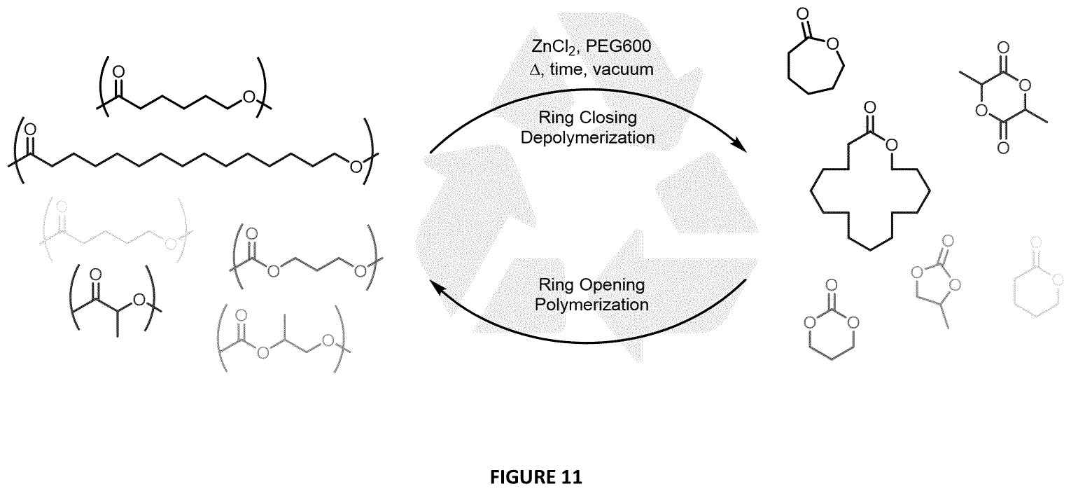

In summary, polyesters and polycarbonates are depolymerized using the combination of zinc dichloride and polyethylene glycol as a catalyst under reactive distillation conditions carried out at temperatures significantly below the ceiling temperature of the polymers evaluated (FIG. 11). Selective polyester depolymerization occurred in the presence of other polymer classes, thereby demonstrating the promise for using the chemistry for the chemical recycling of plastics.

### Materials and Methods

Unless otherwise stated, all manipulations were set up in the benchtop in air. All air sensitive reactions were carried out in oven-dried glassware in a nitrogen-filled glove box or with standard Schlenk line techniques. Unless otherwise stated, solvents were used after passage over alumina through a solvent purification system under a blanket of argon and then degassed briefly by exposure to vacuum.

Unless otherwise stated, materials used were purchased from either Fisher Scientific or Sigma-Aldrich. ε-caprolactone, valerolactone, and 6-hexadecenelactone monomers were purchased from Fisher Scientific. Pentadecanelactone, propylene carbonate, and ethylene carbonate were purchased from Sigma-Aldrich. Liquid monomers were dried over CaH₂ and distilled prior to being transferred into a nitrogen filled glovebox. Solid monomers were dried overnight under vacuum before being transferred to a nitrogen filled glovebox. Monomers were further dried by passing through alumina inside a nitrogen filled glovebox where they were stored prior to use. Enantiomer pure L-Lactide was purchased from Natureworks and was further purified by recrystallization from ethyl acetate followed by recrystallization from hot toluene and dried under vacuum before being transfer to a nitrogen filled glovebox. Depolymerization solvents were used as purchased without further purification. Polymers used for depolymerization were synthesized following previously described procedures. All polymers were dried under vacuum overnight before use in depolymerization studies.

Nuclear Magnetic Resonance (NMR): NMR spectra were recorded at ambient temperature on spectrometers with 400, 500, or 600 MHz instruments for ¹H NMR. An acquisition time (at) of 2.05 seconds and a relaxation delay (d1) of 25 seconds was used for quantitative ¹H NMR, which was greater than 3*t1 used for analysis.

Gel Permeation Chromatography (GPC): Unless otherwise stated, polymer molecular weights were determined by GPC using an Agilent GPC2200 in THF at 40° C. with three PL gel columns (10 μm) in series and signal was recorded with a refractive index detector. Molecular weights were determined relative to polystyrene standards.

Thermogravimetric Analysis (TGA): TGA was conducted using a NETZSCH Thermal Analysis 449 F1 Jupiter STA using an inert nitrogen carrier and protective gas. Dynamic TGA was conducted at a heating rate of 4° C./min from 25° C. to 500° C. Stepped isothermal TGA was conducted by first heating to 100° C. at 10°/min and then holding at that temperature for 30 minutes followed by heating at a rate of 10°/min to the next heating step going by 10 degree steps up to 200 or 280° C.

Optical Rotation: Optical rotation of lactide was measured using a Rudolph Research Analytical Autopol IV Automatic Polarimeter in dichloromethane using a 10 cm long path length cell and using a wavelength of 589 nm.

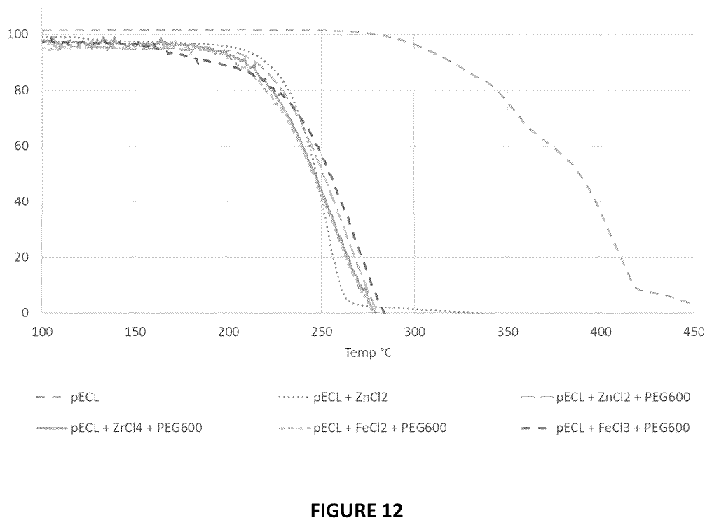

Lewis Acid Screen: Initial screening of catalysts for depolymerization was accomplished through dynamic TGA heating of pECL in the presence of simple Lewis Acids (Table 2) and PEG600 (FIG. 12). Samples were heated from 50° C. to 500° C. at a rate of 4°/min with a flow of N₂ gas. Samples were prepared by weighting out pECL (24 mg, 210 μmol) into an aluminum crucible. To the same crucible, Zinc Chloride (5.3 mg, 38 μmol) was added to the crucible. The crucible was sealed by cold welding an aluminum lid and the lid was pieced before being heated in the TGA.

TABLE 2
Degradation of pECL in the presence of Lewis acid catalysts in the
TGA operating under flow of N₂, and heating from 50-500° C. at 4°/min.

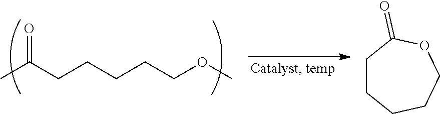

| Catalyst | T_{d5%} (° C.) | T_{d95%} (° C.) |
|---|---|---|
| None | 306 | 441 |
| ZnCl₂ | 206 | 263 |
| Zn(Otf)₂ | 261 | 279 |
| FeCl₃ | 181 | 325 |
| FeCl₂ | 238 | 319 |
| CuBr₂ | 358 | 417 |

Solvent Screen for 1 ATM Depolymerization of pECL

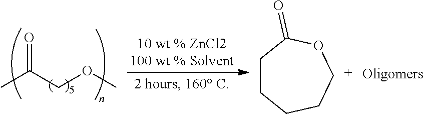

Procedure for solvent screen: In a 4 mL vial containing a stir bar, pECL (50 mg, 0.43 mmol) was added to the vial. To the same vial, Zinc dichloride (5 mg, 0.03 mmol), and trimethoxybenzene (10 mg, 0.060 mmol), which was used as an internal standard, were added to the vial. The solvent (50 mg) being tested was then added to the vial. The vial was capped with a Teflon lined cap and heated to 160° C. while stirring for two hours. The vial was brought to room temperature, and the contents of the vial were dissolved in dichloromethane (2 mL) and filtered through a silica plug in a glass pipette. The dichloromethane was removed under vacuum, and the remaining residue was dissolved In deuterated chloroform (0.65 mL). ¹H NMR was used to determine the yield of monomer (4.2 ppm, t, CH₂ α to CO) and the yield of the polymer and short chain oligomers (4.05 ppm, m, CH₂ α to CO) using trimethoxybenzene (6.0 ppm, s, aromatic CH) as an internal standard (Table 3).

TABLE 3
Solvent Screen for the depolymerization of p(ECL) in solution.

| | Monomer | Polymer | Mass Balance |
|---|---|---|---|
| Solvent | Yield (%) | Yield (%) | (%) |
| Ethylene Glycol | 17 | 57 | 74 |
| PEG600 | 5 | 71 | 77 |
| PEG20000 | 5 | 81 | 86 |
| Tetraglyme | 5 | 87 | 92 |
| p(THF) | 2 | 52 | 54 |
| diphenylether | 2 | 7 | 9 |
| 1,6 hexanediol | 2 | 80 | 82 |
| 1,5 pentanediol | 1 | 27 | 28 |
| glycerin | 1 | 7 | 8 |
| 1,8 Octidiol | 0 | 89 | 89 |
| Eicosane | 0 | 68 | 68 |
| None | 0 | 21 | 21 |

Note:
Polymer and monomer yield determined by ¹H NMR using trimethoxybenzene as an internal standard.

Reactive Distillation Depolymerization of pECL

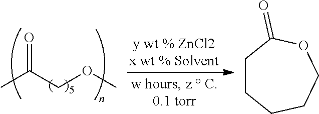

General Procedure for Reactive Distillation: Representative procedure for the reactive distillation depolymerization of pECL. pECL (0.9992 g, 8.750 mmol) was added to a tared 10 mL round bottom flask containing a stir bar. Zinc Chloride (0.0995 g, 0.732 mmol) was added to the flask followed by PEG600 (1.171 g, 2.660 mmol). The flask was fitted to a short path distillation head with a tared 10 mL round bottom flask used to collect the distillate. The apparatus was placed under a 0.1 torr vacuum, and heated to 160° C. The receiving flask was placed in a −20° C. cooling bath, maintained by an immersive cooler, to ensure that the monomer did not evaporate at extended reaction times. The reaction was allowed to stir while heating under vacuum for 16 hours. The reaction apparatus was brought to room temperature, and the reaction and collection flasks were weighed to evaluate how much polymer remained and the amount of monomer recovered, respectively. An aliquot was taken from the receiving flask to measure monomer purity by ¹H NMR using trimethoxybenzene as an internal standard. Yields and monomer purity are reported in FIG. 8.

### Depolymerization Time Course Reactive Distillation

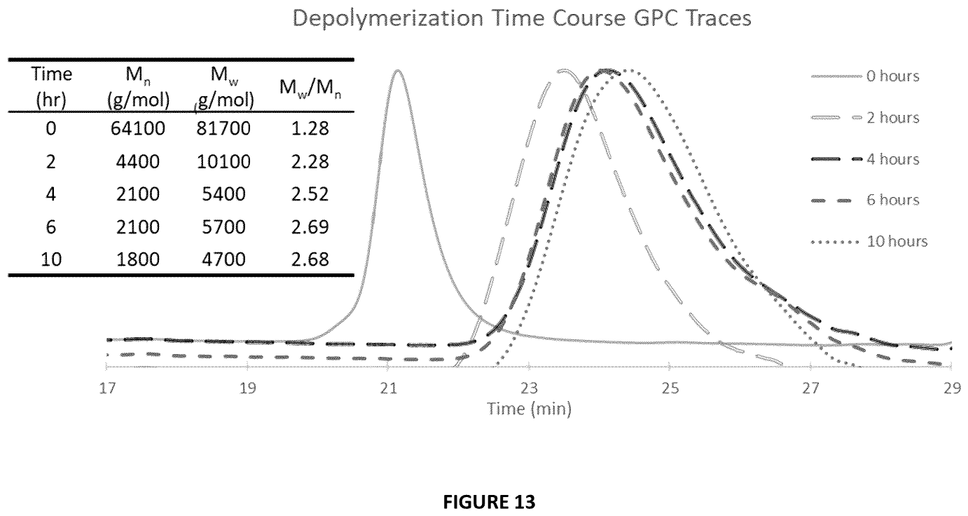

Depolymerization for the time course experiments that appear in FIG. 6A, FIG. 6B, and FIG. 13 were conducted as individual experiments set up according to the general reactive distillation depolymerization procedure. At the indicated time, the reaction was removed from the heating bath and allowed to cool to room temperature. In addition to the general procedure, the remaining polymer residue was sampled and the molecular weight and dispersity was measured by GPC. (RI 1.407, Dₙ/D_{c}=0.049, Mark-Houwink K=14.1, Mark-Houwink α=0.700).

### ZnCl₂: Poly(Ethylene Glycol) Stoichiometry Determination

To determine the optimal ZnCl₂: Ethylene Glycol Repeat Unit stoichiometry reactive distillation was conducted with varying molar fractions of ethylene glycol repeat unit and ZnCl₂ akin to a Job plot analysis or method of continuous variation analysis (Table 4). All reactions were evaluated after four hours to obtain depolymerization yields at partial depolymerization conditions. A total of 0.2 equivalents of ethylene glycol repeat units (repeat unit of poly(ethylene glycol)=OCH₂CH₂) and ZnCl₂ were used relative to the repeat unit of poly(c-caprolactone). The ratio between ethylene glycol repeat unit and ZnCl₂ was varied from 100:0 to 0:100 to determine the optimal ratio.

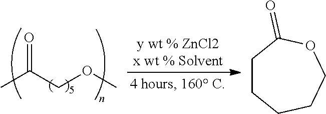

TABLE 4
Data for Stoichiometry Determination.

| Mole Fraction | Polymer | Distillate | Monomer |
|---|---|---|---|
| EGRUª | Mass Loss (%) | Mass(%) | Purity (%) |
| 0 | 19 | 12 | 31 |
| 10 | 23 | 21 | 62 |
| 25 | 12 | 12 | 79 |
| 33 | 11 | 10 | 81 |
| 38 | 17 | 13 | —^{b} |
| 45 | 13 | 9 | 80 |
| 59 | 16 | 12 | —^{b} |
| 67 | 33 | 16 | 91 |
| 81 | 14 | 10 | 86 |
| 94 | 5 | 5 | —^{b} |
| 100 | 2 | 1 | —^{b} |

^{a}EGRU = Ethylene Glycol polymer repeat unit (—CH2CH2O—).
^{b}Purity of collected distillate not measured.

### ω-Pentadecalactone Polymerization

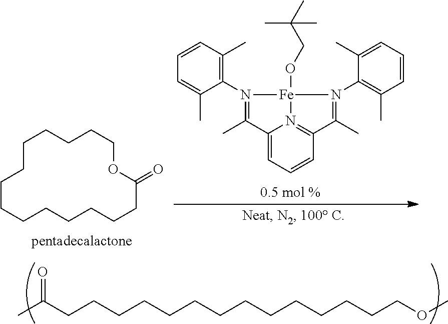

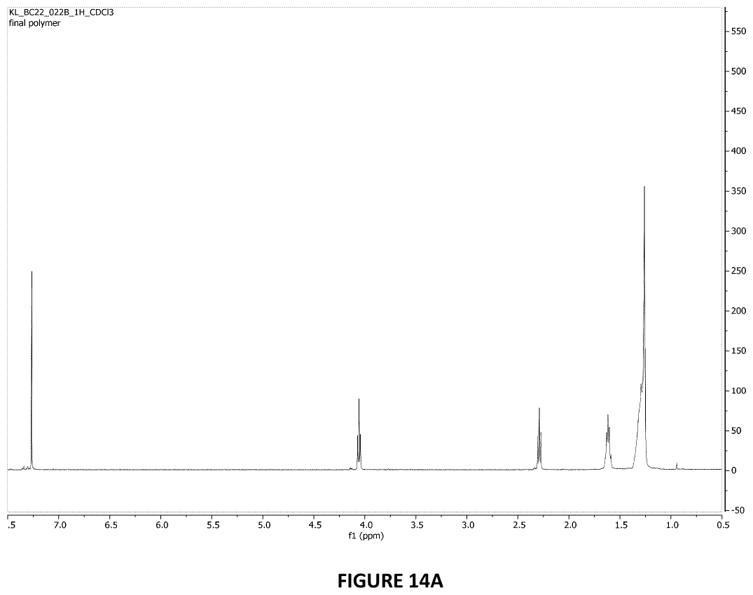

In a nitrogen filled glovebox, ω-pentadecalactone (500 mg, 2.08 mmol) was weighed into a 10 mL round bottom flask with a stir bar. 2,6 dimethyl bis(imino)pyridine Iron (I) neopentoxide (5.3 mg, 10. μmol) was added to the flask, and an 180° ground-glass joint with a vacuum adapter was affixed to the flask. The sealed flask was removed from the glovebox, and placed in an oil bath preheated to 100° C. The reaction was carried out for six hours, and then stopped by exposing it to air and then allowing it to cool to room temperature. ¹H NMR of the crude reaction indicated 90% conversion to the ring opened product by comparing integration of CH₂ adjacent to the ester functional group in the monomer and polymeric species (FIG. 14A). The product was isolated by dissolving in a minimal amount of chlorobenzene (˜2 mL) and then adding it dropwise to ice cold methanol (150 mL). The precipitated polymer was recovered by benchtop centrifugation (5000 RPM) and filtration. The final product was collected in a tared 2 dram scintillation vial and was dried overnight under vacuum to give an orange fluffy powder (0.400 g, 1.80 mmol, 80% isolated yield). The ¹H NMR spectrum of the isolated polymer (FIG. 14B) was consistent with previously reported literature: ¹H NMR (500 MHz, CDCl₃): d 4.16-4.09 (A, t, 2H), 2.38-2.26 (N, t, 2H), 1.78-1.54 (B+M, m, 4H), 1.48-1.17 (C-L, m, 20 H) ppm. Polymer molecular weight was determined by end-group analysis using ¹H NMR and using high temperature (140° C.) GPC using trichlorobenzene as solvent. Mₙ (NMR)=27.4 kg/mol (Chain peak at δ 4.06 (t, J=6.8 Hz, 2H) ppm, end group peak at δ 0.9 (s, 9H) ppm, Mₙ (GPC)=29.5 kg/mol, M_{w}/Mₙ 3.39. (RI 1.572, dn/dc =0.053, Mark-Houwink K=12.1, Mark-Houwink α=0.707).

### Substrate Scope

Unless otherwise noted, the substrate scope was carried out using the general reactive distillation procedure.

ε-caprolactone

TABLE 5
ε-caprolactone.

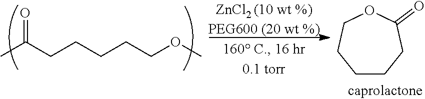

| | Monomer | Monomer | Mass |
|---|---|---|---|
| Monomer | Yield % | Purity % | Balance % |
| ε-caprolactone | 100 | 100 | 97 |

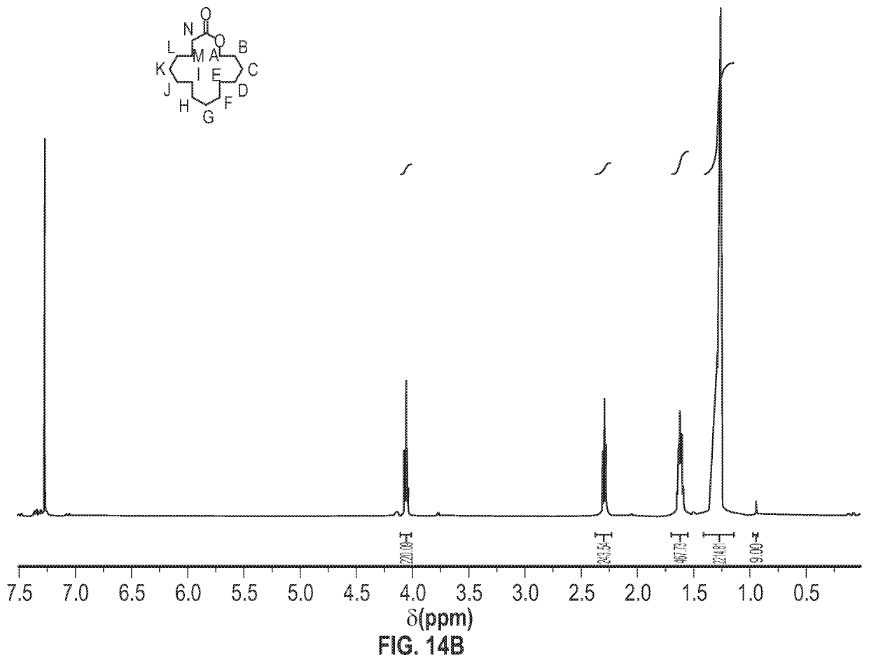

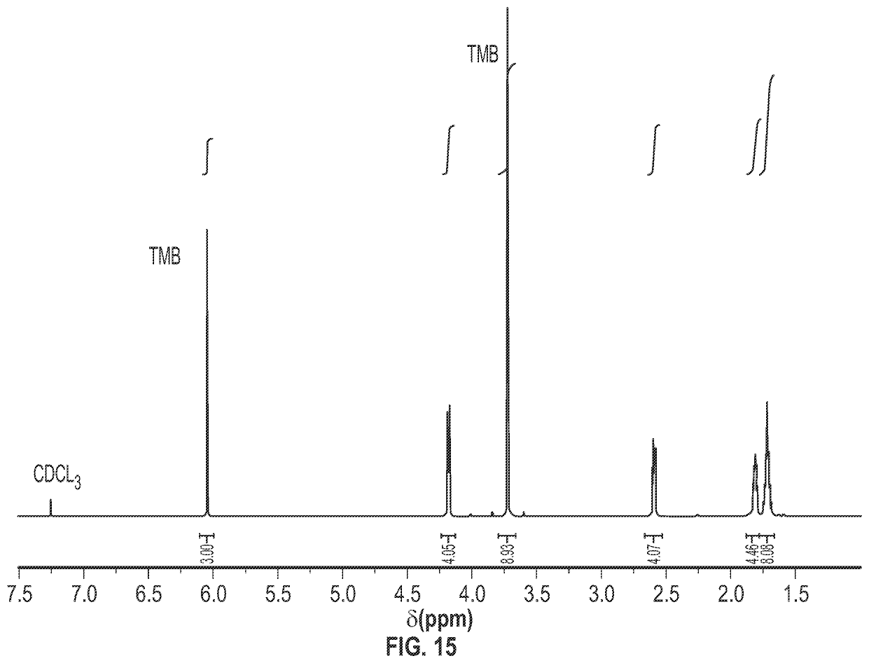

¹H NMR of collected distillate from reactive distillation of pECL is presented in FIG. 15.

δ-valerolactone

TABLE 6
δ-valerolactone.

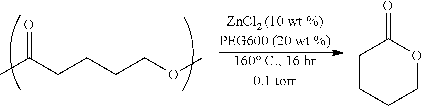

| | Monomer | Monomer | Mass |
|---|---|---|---|
| Monomer | Yield | Purity | Balance |
| δ-valerolactone | 93 | 99 | 96 |

| | | | | | | | Mass | |
|---|---|---|---|---|---|---|---|---|
| | | | | | % | Mass | Re- | |
| | Time | Temp | Polymer | ZnCl2 | Solvent | Bal- | main- | Polymer |
| Monomer 1 | (hr) | (C) | (g) | (g) | Weight | ance | ing | Left |
| Voirolactone | 16 | 160 | 0.4742 | 0.0527 | 33.25601 | 56.39 | 0.2122 | 0.379587 |

| % | | | | | | Mono- | | % | |
|---|---|---|---|---|---|---|---|---|---|
| Mass | | | | | | mer | | Mono- | |
| Col- | | | | | | 1 | | mer | % |
| lected | TM8 | Sam- | TM8 | Mono- | Mono- | Inte- | | 1 | yield |
| Distil- | (iS) | ple | (6.07 | mer | mer | gra- | | Distil- | Mono- |
| late | (g) | (g) | ppm) | 1 PPM | 1 #Hs | tion | g M1 | late | mer |
| 94.412 | 0.012 | 0.0514 | 3 | 4.31 | 2 | 14.24 | 0.443 | 98.95 | 93.42 |

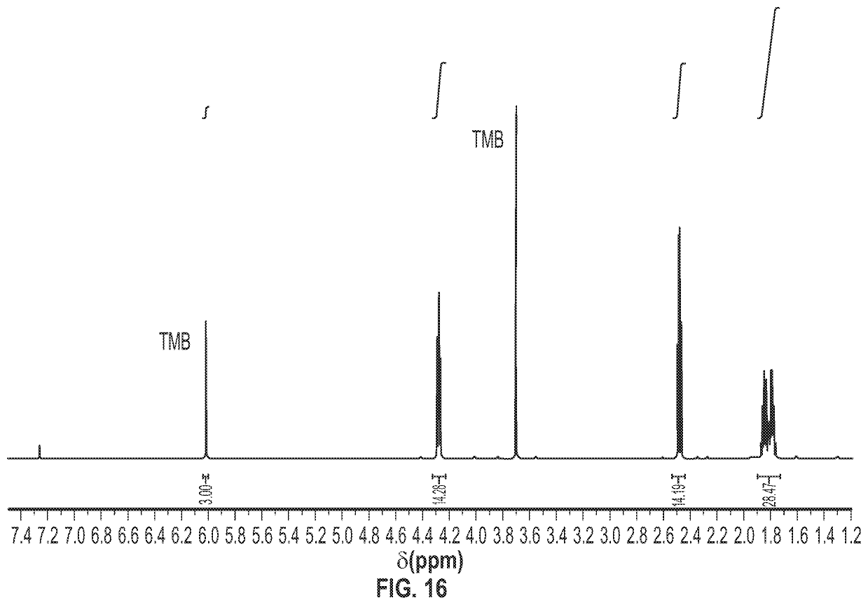

¹H NMR of collected distillate from reactive distillation of poly(δ-valerolactone) is presented in FIG. 16.

### L-lactide

TABLE 7
L-lactide.

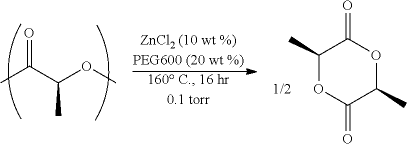

| | Monomer | Monomer | Mass |
|---|---|---|---|
| Monomer | Yield | Purity | Balance |
| L-lactide | 98 | 100 | 98 |

| | | | | | | | | |
|---|---|---|---|---|---|---|---|---|
| Monomer | | | Polymer | | % Solvent | Mass | Mass | Polymer |
| 1 | Time (hr) | Temp (C) | (g) | ZnCl2 (g) | Weight | Balance | Remaining | Left |

| | | | | | | | | |
|---|---|---|---|---|---|---|---|---|
| L-Lactide | 16 | 160 | 0.508 | 0.0518 | 19.74409 | 97.58 | 0.3471 | −0.98425 |

| | | | | | | | | % | |
|---|---|---|---|---|---|---|---|---|---|
| % Mass | TM8 | | TM8 | | | Monomer | | Monomer | |
| Collected | (iS) | Sample | (6.07 | Monomer | Monomer | 1 | | 1 | % yield |
| Distillate | (g) | (g) | ppm) | 2 PPM | 1 #Hs | Integration | g M1 | Distillate | Monomer |
| 97.835 | 0.0198 | 0.0194 | 3 | 5.04 | 2 | 2.95 | 0.4954 | 99.58 | 97.52 |

TABLE 8
Enantiomeric excess (ee) of depolymerized pLLA.

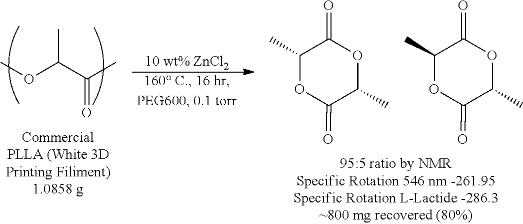

| Sample | Pure | |
|---|---|---|
| (589 nm) | (589 nm)* | ee (%) |
| −264.82 | −266.3 | 99.4 |

*Lidong Feng, Xinchao Bian, Zhiming Chen, Sheng Xiang, Yanlong Liu, Bin Sun, Gao Li, Xuesi Chen Talanta, 2017, 164, 268.

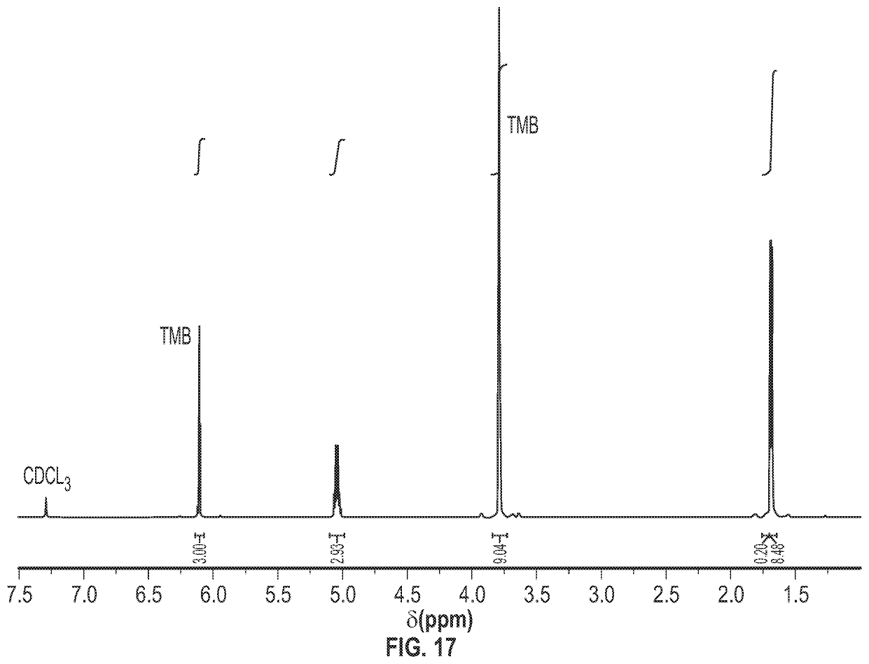

¹H NMR of collected distillate from reactive distillation of pLLA is presented in FIG. 17.

### Propylene Carbonate

TABLE 9
Propylene carbonate.

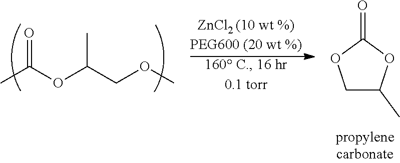

| Monomer | Monomer Yield | Monomer Purity | Mass Balance |
|---|---|---|---|
| Propylene Carbonate | 86 | 90 | 92 |

| | | | Polymer | | % Solvent | Mass | Mass | Polymer |
|---|---|---|---|---|---|---|---|---|
| Monnoter 1 | Time (hr) | Temp (C) | (g) | ZnCl2 (g) | Weight | Balance | Remaining | Left |
| Propylene Carbonate | 16 | 160 | 0.4888 | 0.0525 | 27.33224 | 91.69 | 0.152 | −6.97627 |

| | | | | | | | | | |
|---|---|---|---|---|---|---|---|---|---|
| | | | | | | | | % | |
| % Mass | | | TM8 | | | Monomer | | Monomer | |
| Collected | | Sample | (6.07 | Monomer | Monomer | 1 | | 1 | % yield |
| Distillate | TM8 (iS) (g) | (g) | ppm) | 1 PPM | 1 #Hs | Integration | g M1 | Distillate | Monomer |

| | | | | | | | | | |
|---|---|---|---|---|---|---|---|---|---|
| 95.499 | 0.009 | 0.0407 | 3 | 1.45 | 3 | 20.097 | 0.4192 | 89.8 | 85.75 |

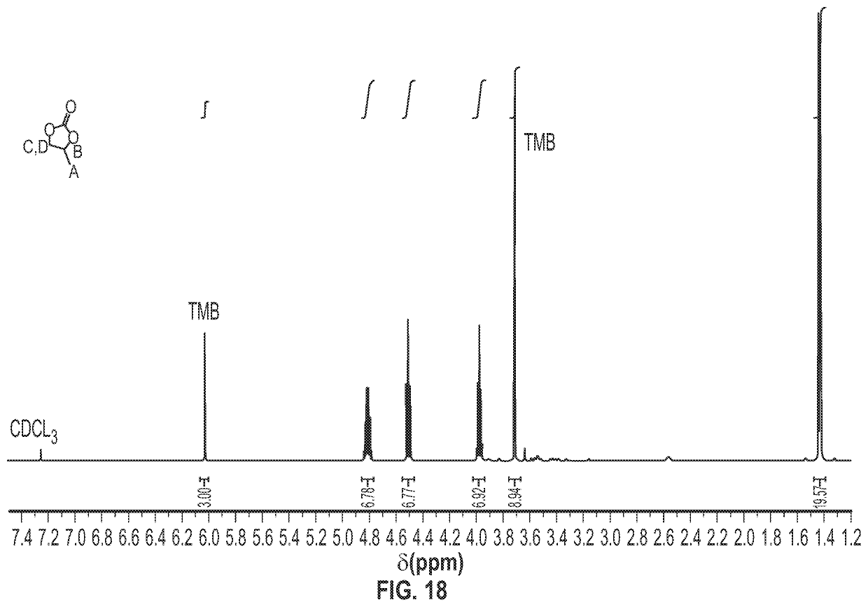

¹H NMR of collected distillate from reactive distillation poly(propylene carbonate) is presented in FIG. 18.

### Trimethylene Carbonate

TABLE 10
Trimethylene carbonate.

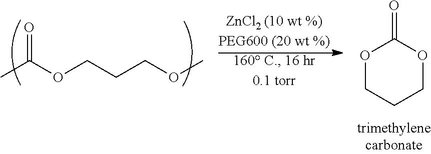

| | Monomer | Monomer | Mass |
|---|---|---|---|
| Monomer | Yield | Purity | Balance |
| Trimethylene carbonate | 85 | 98 | 77 |

| | | | Polymer | | % Solvent | Mass | Mass | Polymer |
|---|---|---|---|---|---|---|---|---|
| Monomer 1 | Time (hr) | Temp (C) | (g) | ZnCl2 (g) | Weight | Balance | Remaining | Left |
| Trimethylcarbonate | 16 | 160 | 0.4135 | 0.0369 | 23.99033 | 52.26 | 0.184 | 11.58404 |
| Trimethylcarbonate | 16 | 160 | 0.4135 | 0.0369 | 23.99033 | 76.02 | 0.184 | 13.58404 |

| | | | | | | | | % | |
|---|---|---|---|---|---|---|---|---|---|
| % Mass | | | TM8 | | | Monomer | | Monomer | |
| Collected | | Sample | (6.07 | Monomer | Monomer | 1 | | 1 | % yield |
| Distillate | TM8 (iS) (g) | (g) | ppm) | 1 PPM | 1 #Hs | Integration | g M1 | Distillate | Monomer |
| 24.958 | 0.0058 | 8.0039 | 3 | 2.13 | 2 | 2.19 | 0.102 | 98.85 | 24.67 |
| 56.542 | 0.009 | 0.0171 | 3 | 2.13 | 2 | 6.64 | 0.248 | 3.06.08 | 59.97 |

*Material collected both in distillation head and receiving flask.

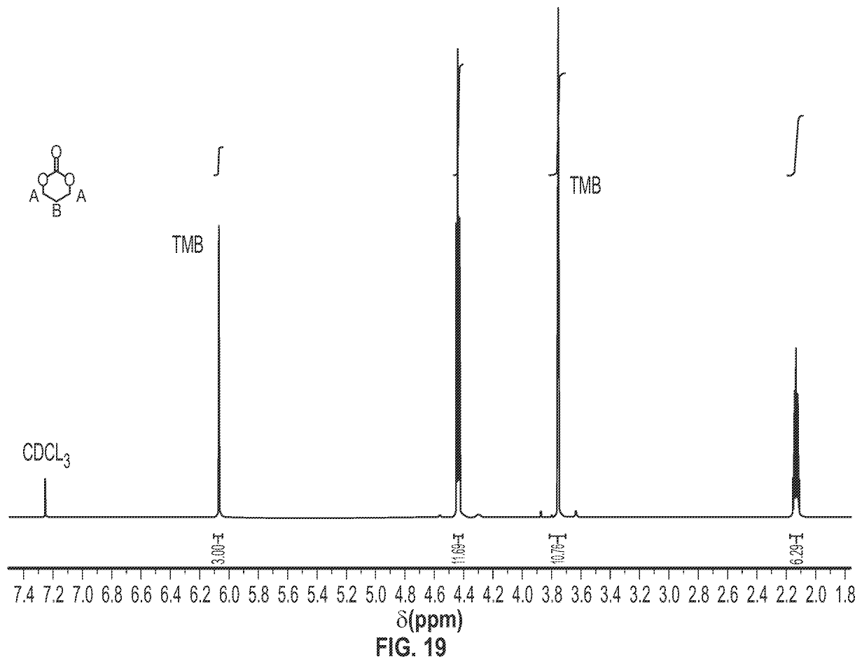

¹H NMR of collected distillate from reactive distillation of poly(trimethylene carbonate) is presented in FIG. 19.

### ω-Pentadecalactone

TABLE 11
ω-Pentadecalactone.

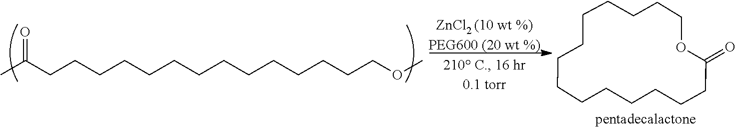

| | Monomer | Monomer | Mass |
|---|---|---|---|
| Monomer | Yield | Purity | Balance |
| ω-Pentadecalactone | 95 | 97 | 95 |

| | | | Polymer | | % Solvent | Mass | Mass | Polymer |
|---|---|---|---|---|---|---|---|---|
| Monomer 1 | Time (hr) | Temp (C) | (g) | ZnCl2 (g) | Weight | Balance | Remaining | Left |
| Pentadacalactone | 16 | 210 | 0.2766 | 0.0312 | 22.95734 | 95.29 | 0.0837 | 3.97686 |

| | | | | | | | | % | |
|---|---|---|---|---|---|---|---|---|---|
| % Mass | | | TM8 | | | Monomer | | Monomer | |
| Collected | | Sample | (6.07 | Monomer | Monomer | 1 | | 1 | % yield |
| Distillate | TM8 (iS) (g) | (g) | ppm) | 1 PPM | 1 #Hs | Integration | g M1 | Distillate | Monomer |
| 97.65 | 0.0112 | 0.0332 | 3 | 4.13 | 2 | 4.03 | 0.2524 | 97.15 | 94.87 |

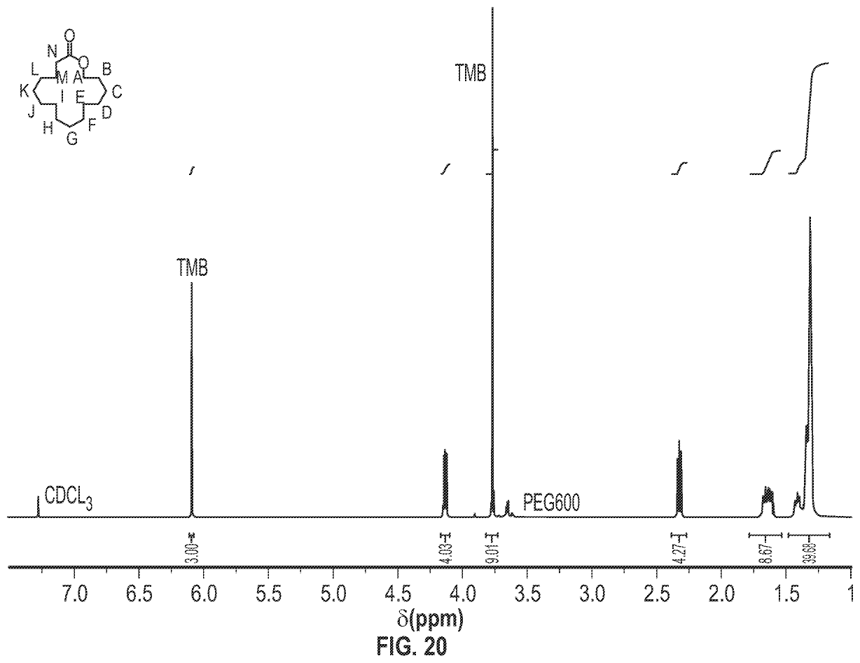

¹H NMR of collected distillate from reactive distillation of pPDL is presented in FIG. 20.

6-hexadecenelactone

TABLE 12
6-hexadecenelactone.

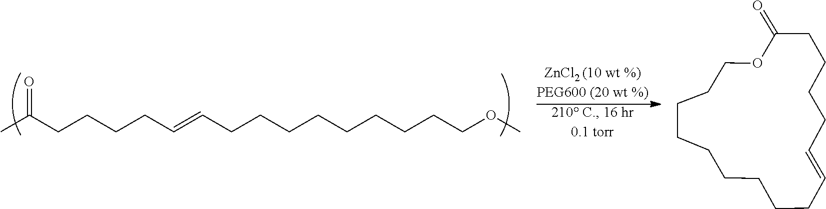

| | Monomer | Monomer | Mass |
|---|---|---|---|
| Monomer | Yield | Purity | Balance |
| 6-hexadecenelactone | 39 | 98 | 83 |

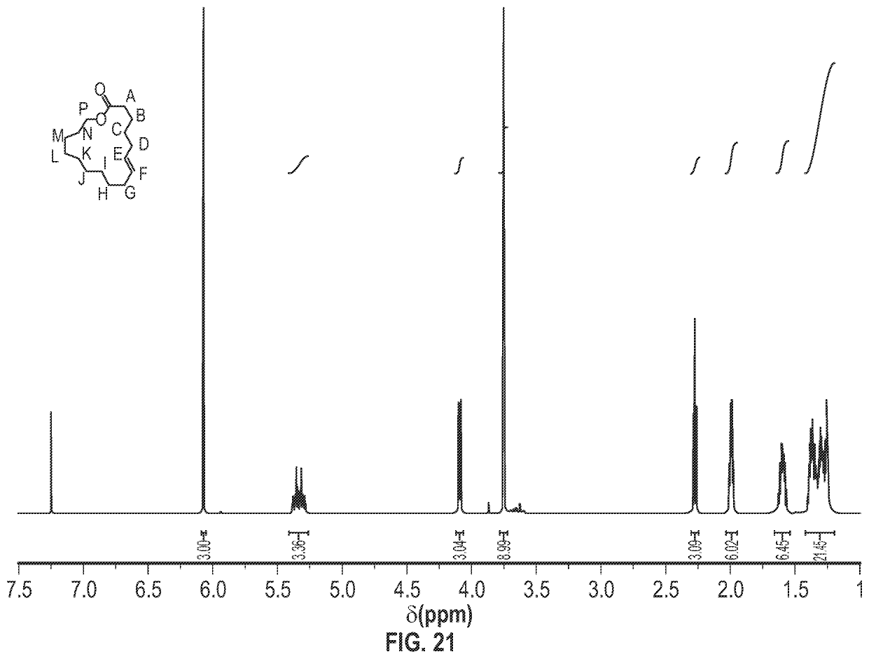

¹H NMR of distillate from recycled p(HDL) is presented in FIG. 21.

### TGA Kinetics

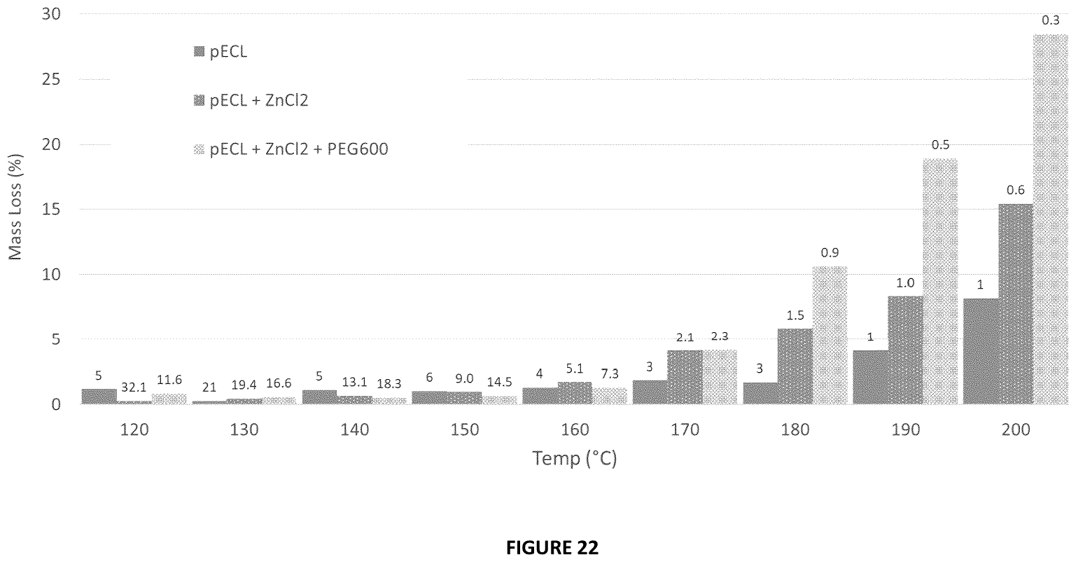

Combined Stepped Isothermal TGA of pECL, Isothermal TGA of pECL with ZnCl₂/PEG600 catalyst system at different temperatures, and Stepped Isothermal TGA of pPDL in the presence of ZnCl₂: PEG600 are presented in FIG. 22, FIG. 4, and FIG. 5, respectively.

### Mixed Waste Polymer Depolymerization

A poly(ethylene phthalate) (PET) soda bottle, an isotactic poly(propylene) (i-PP) cup, and a linear low density poly(ethylene) (LLDPE) plastic bag were cut into small strips to be used as sources for the mixed polymer waste experiment along with p(ECL) synthesized as described previously (FIG. 9A). A reactive distillation depolymerization was carried in a similar fashion as described in the general procedure. In addition to the pECL (0.4082 g, 3.581 mmol) equal weight amounts of PET (0.4473 g, 2.327 mmol), poly(ethylene) (0.3823 g, 13.63 mmol), and poly(propylene) (0.3823 g, 9.085 mmol) plastic products were added to a pre-tared 10 mL round bottom flask along with a stir bar. A second pre-tared round bottom flask was used as the receiving flask. The distillation apparatus was assembled as described in the general reactive distillation procedure and shown in FIG. 9B. The apparatus was placed under a 0.1 torr vacuum, and the reaction flask was submerged in an oil bath preheated to 160° C. The receiving flask was placed in a chilled −20° C. bath to ensure monomer did not evaporate at extended reaction times. The heterogeneous reaction was allowed to stir while heating under vacuum for 16 hours. The reaction was brought to room temperature, and the tared flasks were weighed. An aliquot was taken from the receiving flask to measure monomer recovery and purity by ¹H NMR using trimethoxybenzene as an internal standard. Caprolactone monomer yield was 77% with distillate monomer purity of 92% with a total mass balance of 97%.

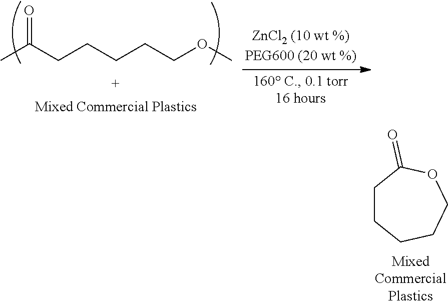

### Catalyst Recycling

TABLE 13
Catalyst recycling data.

| | Polymer | | | Distillate |
|---|---|---|---|---|
| Entry | Remaining | Polymer | Yield Purity | Mass Balance |
| 1 Original | 0.1 | 85.94 | 99.45 | 89.81 |
| 2 ^{1s}t Recycle | −0.2 | 86.39 | 98.62 | 87.39 |
| 3 ²ⁿd Recycle | 0.2 | 80.31 | 96.39 | 83.56 |
| 4 ^{3r}d Recycle | 11.7 | 63.43 | 99.37 | 75.57 |
| 5 ^{4t}h Recycle | 12.3 | 62.88 | 98.32 | 76.27 |

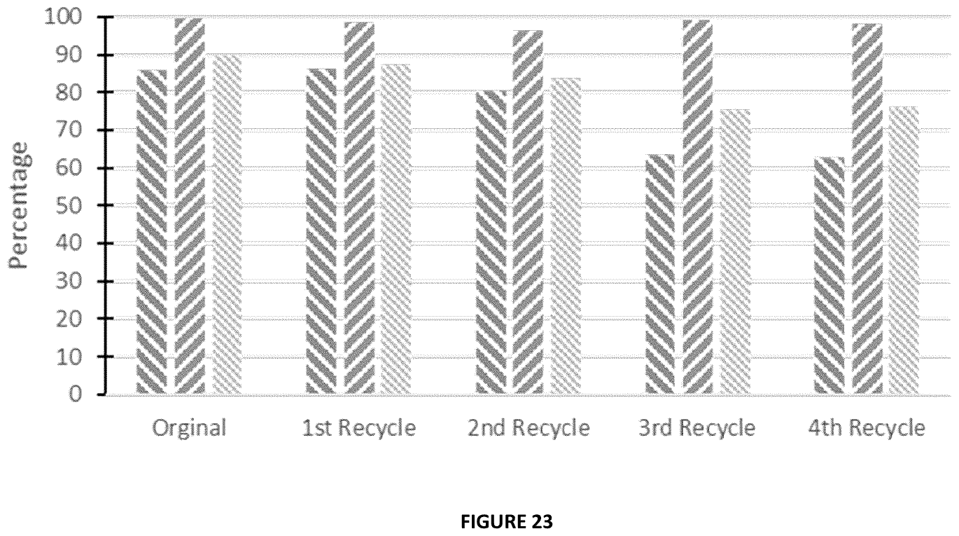

Catalyst recyclability was explored by conducting 5 polymerization reactions using the same batch of catalyst (FIG. 23). Recycling of the catalyst was cimply carried out by removing the distilled monomer from the reactive distillation and replenishing the reaction pot with additional poly(ε-caprolactone). Efficient depolymerization was seen after two recycling of the catalyst (86%, 80%) but yields of the monomer started to decrease as the catalyst system was recycled for a 3r d and 4 th reaction cycle (63%, 63%). While the yields did start to decease upon successive reactions in one pot, the collected monomer purity remained consistent throughout all depolymerization (>98%). The loss in yield between successive reaction may be due to catalyst deactivation.

### Synthesis of Complex 1: 2,6 Dimethylphenyl Bis(Imino)Pyridine Fe (I) Neopentoxide

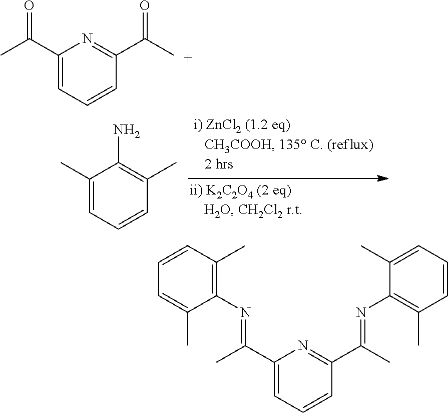

### Synthesis of 2,6 Dimethylphenyl Bis(Imino)Pyridine

2,6-Diacetylpyridine (1 g, 6.13 mmol) and zinc chloride (1.00 g, 7.35 mmol) were weighed out into a 100 mL round bottom flask. A stir bar was added and then acetic acid (25 mL) was added to the flask. The flask was allowed to stir at room temperature for 10 minutes. A white cloudy suspension formed. After 10 minutes 2,6-dimethylaniline (1.78 g, 14.71 mmol, 1.82 mL) was added to the flask. A reflux condenser was connected to the round bottom and the round bottom flask as submerged in an oil bath and the mixture was kept under reflux for 2 hours. Upon heating, the mixture changed from a white cloudy suspension to a yellow cloudy suspension. After 2 hours the oil bath was removed and the solution was allowed to cool to room temperature. The mixture was then filtered and the resulting yellow powder washed with a mixture of hexanes and diethyl ether. A yellow powdery solid was collected and transferred to a 250 mL conical flask. Solid was dissolved in 50 mL of dichloromethane and then added to a 250 mL round bottom flask containing potassium oxalate (2.82 g, 15.32 mmol) in 25 mL of water. The solution was then allowed to stir for 30 minutes. The organic layer was collected and the aqueous layer was extracted with dichloromethane (3×50 mL). The organic layer was then dried over sodium sulfate. The mixture was filtered and the solution was transferred to a round bottom flask. The volatiles were removed under reduced pressure to obtain desired products as a yellow powder. If monosubstituted byproduct was observed by 1H NMR, the solid was recrystallized from hot methanol to afford the desired product.

¹H NMR (500 MHz, Chloroform-d) δ 8.53 (d, J=7.9 Hz, 2H), 7.94 (t, J=7.8 Hz, 1H), 7.10 (d, J=7.5 Hz, 4H), 6.97 (t, J=7.6 Hz, 2H), 2.26 (s, 6H), 2.08 (s, 12H) ppm.

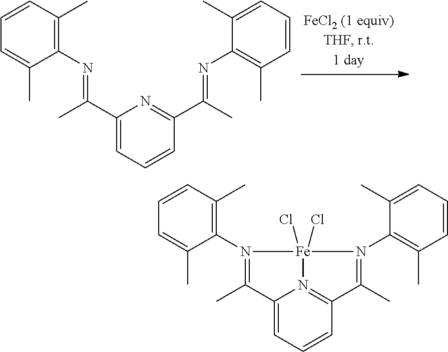

### Synthesis of 2,6 Dimethylphenyl Bis(Imino)Pyridine Iron Dichloride

In a nitrogen-filled glovebox, iron dichloride (303.93 mg, 2.40 mmol) was weighed out into a 20 mL scintillation vial. A stir bar was added and THF (3 mL) was added to the vial. The vial was capped and placed on a stir plate for 15 minutes. 2,6 dimethylphenyl bis(imino)pyridine (886 mg, 2.40 mmol) was dissolved in a separate large vial in THF (12 mL). This solution was added by pipette into the stirring iron dichloride suspension. Upon addition of the yellow ligand solution the brown, iron-containing, suspension changed to a dark purple color. The large vial was capped and then allowed to stir for an additional 24 hours. After 24 hours diethyl ether was added to the vial and then the solid was collected on a filter frit and washed with additional diethyl ether. 2,6 dimethylphenyl bis(imino)pyridine iron dichloride (1.12 g, 2.26 mmol, 94.12% yield) was collected in a vial and dried by vacuum to give a light purple solid. The material was used without further purification.

¹H NMR (500 MHz, dichloromethane-d₂) δ 82.36 (s, 1H), 15.88 (s, 1H), 11.86 (s, 4H), 5.34 (s, 3H), 3.70 (s, 1H), 1.84 (s, 1H), −10.96 (s, 1H), −21.19 (s, 2H) ppm.

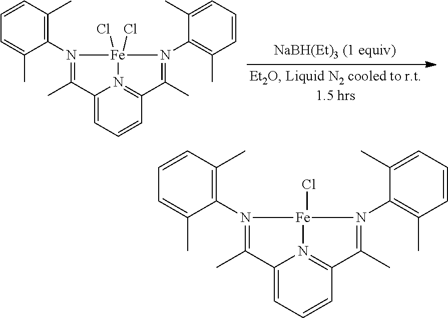

Synthesis of 2,6 Dimethyl Iron (I) Bis(Imino)Pyridine Monochloride

2,6 dimethylphenyl bis(imino)pyridine iron dichloride (1.28 g, 2.58 mmol) was weighed out in a large vial. A stir bar was added and ˜10 mL of Diethyl Ether was added and allowed to stir for 10 minutes. In a separate large vial sodium triethylborohydride (1 M, 2.58 mL) was added with a syringe. 3 mL of Diethyl Ether was added to the vial. Both vials were then placed in a glovebox coldwell that was cooled by liquid nitrogen for 20 minutes. After 20 minutes sodium; triethylboranuide (1 M, 2.27 mL) solution was added to the stirring solution of the Iron dichloride with a pipette dropwise. Upon addition, the solution turned from purple color to dark green color. After addition vial was capped and allowed to stir at RT for 3 hours. After 3 hours solution was filtered through celite and washed with additional diethyl ether. Diethyl ether was removed by vacuum to dryness. The resulting solid was then dissolved in diethyl ether and transferred to a vial and placed in the glovebox freezer. After sitting overnight in the glovebox freezer liquid was decanted into a new vial and the resulting black solid was rinsed with pentane and then placed under vacuum to dry the sample. Resulting in the desired product 2,6 dimethylphenyl bis(imino)pyridine iron monochloride (491.3 mg, 41.34% yield).

¹H NMR (500 MHz, Benzene-d6) δ 206.97 (s, 1H), 63.64 (s, 1H), 3.31 (s, 2H), 1.23-1.13 (m, 1H), 1.08 (s, 3H), 0.82 (d, J=6.6 Hz, 1H), −6.67-−6.71 (m, 2H), −16.10 (s, 1H), −41.09 (s, 5H) ppm.

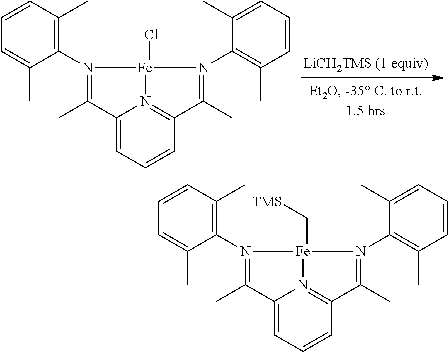

### Synthesis of 2,6 Dimethylphenyl Bis(Imino)Pyridine Iron Alkyl

2,6 dimethylphenyl Iron (I) bis(imino)pyridine monochloride (491.3 mg, 1.07 mmol) was weighed out into a large vial with a stir bar. 5 mL of diethyl ether was then added to the vial. In a separate vial trimethylsilylmethyllithium (100.39 mg, 1.07 mmol) was weighed out and 3 mL of diethyl ether was added. Both vials were added to the glovebox coldwell cooled by liquid nitrogen for 20 minutes. The vials were removed and with a pipette, the solution of trimethylsilymethyllitium was added dropwise to the solution of the Fe complex. After the addition was complete the vial was capped and the solution allowed to stir at room temperature for 1.5 hrs. The solution was then filtered over celite and the solvent then removed under vacuum. Desired 2,6 dimethylphenyl bis(imino)pyridine iron alkyl (418 mg, 815.51 umol, 76.49% yield) was obtained.

¹H NMR (600 MHz, Benzene-d6) δ 65.61 (s, 1H), 38.14 (s, 3H), 1.21 (dd, J=14.0, 7.1 Hz, 1H), 1.20-1.12 (m, 1H), 0.82 (q, J=6.2, 5.4 Hz, 2H), −10.90 (s, 1H), −17.06 (s, 1H), −49.78 (s, 4H) ppm.

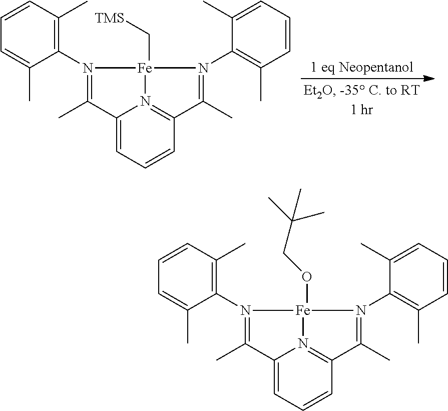

### Synthesis of the 2,6 Dimethylphenyl Bis(Imino)Pyridine Iron Neopentyloxide

2,6 dimethylphenyl bis(imino)pyridine iron alkyl (418 mg, 815.51 umol) was placed in a large vial with a stir bar added. Neopentanol (71.89 mg, 815.51 umol, 87.88 uL) was weighed out into a separate vial. Diethyl ether that had been cooled in the freezer was added to both vials. The neopentanol was then transferred to the vial containing the Iron complex and allowed to stir for 1 hour. After 1 hour the solution was evaporated to dryness under vacuum to yield the desired product, 2,6 dimethylphenyl bis(imino)pyridine iron neopentyloxide (400 mg, 780.51 umol, 95.71% yield).

1H NMR (600 MHz, Benzene-d6) δ 67.41 (s, 1H), 50.41 (s, 3H), 7.23 (s, 6H), 3.19 (s, 1H), 2.11 (s, 1H), 1.98 (s, 1H), 1.18 (s, 3H), 1.05 (s, 2H), 0.81 (s, 2H), −9.95 (s, 1H), −15.79 (s, 1H), −49.73 (s, 4H).

### REFERENCES

1. G. Coates, Y. Getzler, Nature Reviews Materials, 2020, 5, 501.

2. K. Law & R. Narayan, Nature Reviews Materials, 2022, 7, 104 c) M. Hong and E. Chen, Green Chem., 2017, 19, 3692.

3. K. Ragaert, L. Delva, K. Van Geem, Waste Management, 2017, 69, 24.

4. M. Heller, M. Mazor, G. Keoleian, Environ. Res. Lett, 2020, 15, 094034.

5. C. Shi, L. Reilly, V. Kumar, M. Coile, S. Nicholson, L. Broadbelt, G. Beckham, E. Chen, Chem, 2021, 7, 2896.

6. F. S. Dainton, K. J. Ivin, Nature, 1948, 162, 705.

7. M. Hong, E. Chen Nature Chemistry, 2016, 8, 42.

8. M. Hong, E. Chen Ang. Chem. Int. Ed., 2016, 55(13), 4188.

9. D. Schneiderman, M. Vanderlaan, A. Mannion, T. Panthani, D. Batiste, J. Wang, F. Bates, C. Macosko, and M. Hillmyer ACS Macro Lett. 2016, 5, 4, 51.

10. C. Li, L. Wang, Q. Yan, F. Liu, Y. Shen, Z. Li Agew. Chem. 2022, 61, e202201407.

11. J. Zhu, E. M. Watson, J. Tang, and E. Chen Science, 2018, 360(6387), 398.

12. J. Zhu, E. Chen Angew. Chem. 2019, 131, 1190.

13. J. P. MacDonald, M. P. Shaver Polymer Chemistry, 2016, 7, 3, 553.

14. C. Shi, Z.-C. Li, L. Caporaso, L. Cavallo, L. Falivene, E. Chen, Chem 2021, 7, 670.

15. J. Segovia-Hernández, S. Hernández, and A. Petriciolet Chem. Eng. and Process. 2015, 97, 134.

16. P. Olsén, J. Undin, K. Odelius, H. Keul, and A. Albertsson Biomacromolecules 2016, 17, 3995.

17. I. S. Megna, A. Koroscil Polymer Letters, 1968, 6, 653.

18. C. Alberti, S. Enthaler Chemistry Select 2020, 5, 14763.

19. “Continuous process for the manufacture of lactide and lactide polymers” P. R. Gruber, E. S. Hall, J. J. Kolstad, M. L. Iwen, R. D. Benson, R. L. Borchardt, U.S. Pat. No. 6,277,951, 2001.

20. J Byers, A Biernesser, K Delle Chiaie, A Kaur, J Kehl, Catalytic Systems for the Production of Poly(lactic acid), in Synthesis, Structure and Properties of Poly(lactic acid), M Di Lorenzo, R Androsch, Springer, 2018, 67-118.

21. D Garlottal Polym. Environ. 2001, 9, 63.

22. L. Cederholm, J. Wohlert, P. Olsen, M. Hakkarainen, and K. Odelius Angew. Chem. 2022, e202204531.

23. P. Olsen, K. Odelius, A. Biomacromolecules, 2016, 17, 699.

24. Job, Paul Annales de Chimie. 1928 10 (9), 113.

25. D. Myers, T. Witt, A. Cyriac, M. Bown, S. Mecking and C. K. Williams Polym. Chem., 2017, 8, 5780.

26. J. Cai, C. Liu, M. Cia, J. Zhu, F. Zuo, B. Hsiao, R. Gross Polymer, 2010, 51(2), 1088.

27. A. Martinez-Cutillas, S. Leon, S. Oh and A. Martinez de Ilarduya Polym. Chem., 2022, 13, 1586.

28. S. Enthaler and A. Trautner ChemSusChem, 2013, 6, 1334.

29. V Yashin, A. Isayev Journal of Polymer Science: Part B: Polymer Physics, 2003, 41, 965.

30. Lidong Feng, Xinchao Bian, Zhiming Chen, Sheng Xiang, Yanlong Liu, Bin Sun, Gao Li, Xuesi Chen Talanta, 2017, 164, 268.

31. Joseph S. Renny,Laura L. Tomasevich, Evan H. Tallmadge, David B. Collum Angew. Chem. 2013, 52, 11998.

32. K. R. Delle Chiaie, A. B. Biernesser, M. A. Ortuño, B. Dereli,b D. A. Iovan, M. J. T. Wilding, B. Li, C. J. Cramer and J. A. Byers Dalton Transactions, 2017, 46, 12971.

33. Guillaume Force, Anna Perfetto, Robert J. Mayer, Ilaria Ciofini, and David Leboeuf Angew. Chem. 2021, 60, 19843.

34. Tiziana Fuoco, Angelo Meduri, Marina Lamberti, Vincenzo Venditto, Claudio Pellecchia and Daniela Pappalardo Polym. Chem., 2015, 6, 1727.

35. Rubina Abdul-Karim, Abdul Hameed, Muhammad Imran Malik European Polymer Journal, 2018, 105, 95.

36. Burger, B. J.; Bercaw, J. E. Bercaw Air-Sensitive Chemistry. In Experimental Organometallic Chemistry; ACS Symposium Series, 1987; pp 79-115.

1. A composition for ring closing depolymerization, comprising a polymer, a Lewis acid, and a solvent.

2. The composition of claim 1, wherein the polymer has a ceiling temperature (T_{C}) of ≥150° C.

3. (canceled)

4. The composition of claim 1, wherein the polymer comprises from about 50 wt % to about 90 wt %, about 60 wt % to about 90 wt %, about 70 wt % to about 90 wt %, about 50 wt % to about 80 wt %, about 50 wt % to about 70 wt %, about 60 wt % to about 80 wt %, about 60 wt % to about 70 wt %, about 70 wt % to about 80 wt %, or about 65 wt % to about 75 wt % by weight of the composition.

5. The composition of claim 1, wherein the polymer is selected from a polyester and a polycarbonate.

6. The composition of claim 5, wherein the polyester is selected from poly(ε-caprolactone), poly(w-pentadecalactone), poly(d-valerolactone), poly(L-lactide), and poly(w-6-hexadecenelactone).

7. (canceled)

8. The composition of claim 5, wherein the polycarbonate is selected from poly(propylene carbonate) and poly(trimethylene carbonate).

9. The composition of claim 1, wherein the Lewis acid comprises from about 1 wt % to about 30 wt %, about 1 wt % to about 20 wt %, about 5 wt % to about 20 wt %, about 10 wt % to about 20 wt %, about 1 wt % to about 15 wt %, about 1 wt % to about 10 wt %, or about 5 wt % to about 15 wt % by weight of the composition.

10. The composition of claim 1, wherein the Lewis acid comprises an ion selected from Zn²⁺, Zr⁴⁺, Cu²⁺, Fe²⁺, and Fe³⁺.

11. The composition of claim 10, wherein the ion comprises Zn²⁺.

12. The composition of claim 1, wherein the Lewis acid is selected from ZnCl₂, Zn(OTf)₂, FeCl₃, FeCl₂, and ZrCl₄.

13. The composition of claim 12, wherein the Lewis acid comprises ZnCl₂.

14. The composition of claim 1, wherein the Lewis acid is a Lewis acid catalyst.

15. The composition of claim 1, wherein the solvent comprises from about 1 wt % to about 50 wt %, about 10 wt % to about 50 wt %, about 10 wt % to about 40 wt %, about 10 wt % to about 30 wt %, about 15 wt % to about 30 wt %, about 20 wt % to about 30 wt %, or about 15 wt % to about 25 wt % by weight of the composition.

16. The composition of claim 1, wherein the solvent comprises a polyether, an alcohol, or an ether.

17. The composition of claim 16, wherein the polyether is selected from poly(ethylene glycol) (PEG), tetraethylene glycol dimethyl ether (tetraglyme), poly(tetrahydrofuran), poly(tetramethylene ether), poly(decamethylene ether), and poly(hexadecamethylene ether).

18. The composition of claim 17, wherein the polyether is PEG.

19. The composition of claim 18, wherein the PEG is selected from PEG200, PEG400, PEG600, PEG6000, and PEG20000.

20-24. (canceled)

25. The composition of claim 1, the composition further comprising a monomer of the polymer.

26. (canceled)

27. The composition of claim 25, wherein the monomer is selected from ε-caprolactone, d-valerolactone, L-lactide, w-pentadecalactone, 6-hexadecenelactone, propylene carbonate, and trimethylene carbonate.

28-63. (canceled)
